(19) United States
(12) Patent Application Publication
(10) Pub. No.: US 2026/0260387 A1
(43) Pub. Date: Sep. 3, 2026

(54) NEURAL NETWORKS FOR TRANSFORM COEFFICIENT RECOVERY IN VIDEO CODEC

(71) Applicant: Apple Inc., Cupertino, CA (US)

(72) Inventors: Pengli DU, Cupertino, CA (US); Krishna RAPAKA, Cupertino, CA (US); Aki KUUSELA, Cupertino, CA (US); Xin ZHAO, Cupertino, CA (US); Felix FERNANDES, Cupertino, CA (US); Jaehong CHON, San Diego, CA (US); David WANG, Cupertino, CA (US); Yunfei ZHENG, Cupertino, CA (US); Alexis TOURAPIS, Cupertino, CA (US)

(73) Assignee: Apple Inc., Cupertino, CA (US)

(21) Appl. No.: 19/443,823

(22) Filed: Jan. 8, 2026

Related U.S. Application Data
(60) Provisional application No. 63/766,102, filed on Mar. 3, 2025.

(51) Int. Cl. G06T 9/00; H04N 19/124

(52) U.S. Cl. CPC G06T 9/002; H04N 19/124

(57) ABSTRACT

Embodiments relate to a neural network coupled to a quantization circuitry, a transform circuitry, and a prediction circuitry. The neural network can generate a recovered transform block including recovered transform coefficients for a quantized transformed residual block generated by the quantization circuitry to reduce errors. A first error between the recovered transform block and a transformed residual block generated by the transform circuitry can be smaller than a second error between the transformed residual block and a dequantized transformed residual block generated by performing inverse quantization operations on the quantized transformed residual block, where the first error and the second error are determined based on a cost function.

### RELATED APPLICATIONS

This application claims benefit of U.S. Provisional Patent Application No. 63/766,102 filed on Mar. 3, 2025, the content of which is herein incorporated by references in its entirety.

### FIELD

The present disclosure relates to video compression schemes using neural networks, particularly the neural networks used for transform coefficient recovery in a video codec.

### BACKGROUND

With the development of Internet and various media platform, a growing number of videos or media files are stored, transmitted, and played. Consequently, there is a pressing need to deliver videos or media files with high quality and low costs. Video compression is the process of reducing the file size of a video or media file by reducing the amount of data needed to represent its content, but without losing any or much visual information. A video codec, which combines “encoder” and “decoder,” can compress and decompress media files like video and audio files, sometimes following a video compression standard.

An artificial neural network (ANN) is a computing system or model that uses a collection of connected nodes to process input data. The ANN can be organized into layers, where different layers perform different types of transformation on their input. Extensions or variants of the ANN, such as convolution neural networks (CNN), recurrent neural networks (RNN), and deep belief networks (DBN), have received attention. These computing systems or models can involve extensive computing operations, including multiplication and accumulation. For example, a CNN is a class of machine learning (ML) techniques that uses convolution between input data and kernel data, which can be decomposed into multiplication and accumulation operations.

A CNN can be used in video compression and image restoration of compressed images or video files. The CNN can receive an input, which can be a part of an image or a video frame, and transform the input through a series of hidden layers.

### SUMMARY

Embodiments of the present disclosure include a device used in a video codec that can include a memory device, a prediction circuitry, a transform circuitry, a quantization circuitry, and a neural network coupled in sequence. The prediction circuitry, the transform circuitry, the quantization circuitry, and the neural network can perform operations on an input block of an image containing multiple input blocks. The memory device can be configured to store data of an image including multiple input blocks. The prediction circuitry can be configured to receive an input block of the image and perform a prediction operation to generate a predicted block for the input block. The transform circuitry can be configured to perform a transform to generate a transformed residual block for a residual block between the input block and the predicted block. The quantization circuitry can be configured to perform quantization operations on the transformed residual block to generate a quantized transformed residual block. In addition, the neural network can be configured to generate a recovered transform block including recovered transform coefficients for the quantized transformed residual block to reduce errors introduced by the quantization circuitry. In some embodiments, the first error between the recovered transform block and the transformed residual block can be smaller than a second error between the transformed residual block and a dequantized transformed residual block generated by performing inverse quantization operations on the quantized transformed residual block. The first error and the second error can be determined based on the same cost function. Accordingly, the neural network can generate the recovered transform block with improved quality in comparison with a dequantized transformed residual block generated by directly performing inverse quantization operations.

In some embodiments, a device can include a network interface, a controller coupled to the network interface, and a reconstruction circuitry including a neural network. The network interface can be configured to receive a bit stream from an encoder, where the bit stream can include a quantized transformed residual block of an input block of an image. The quantized transformed residual block can be generated by performing quantization operations by a quantization circuitry of the encoder on a transformed residual block for a residual block determined as a difference between the input block and a predicted block of the input block. The controller can be configured to determine one or more decoding parameters for decoding the bit stream. The neural network of the reconstruction circuitry can be configured to generate a recovered transform block including recovered transform coefficients for the quantized transformed residual block to reduce errors introduced by the quantization circuitry. In some embodiments, a first error between the recovered transform block and the transformed residual block can be smaller than a second error between the transformed residual block and a dequantized transformed residual block generated by performing inverse quantization operations on the quantized transformed residual block, where the first error and the second error are determined based on a cost function.

In some embodiments, a method performed by a device can include storing, in a memory device, data of an image including a plurality of input blocks. Furthermore, the method can include performing, by a prediction circuitry, a prediction operation on an input block of the image to generate a predicted block for the input block; and performing, by a transform circuitry, a transform to generate a transformed residual block for a residual block between the input block and the predicted block. Afterwards, the method can include performing, by a quantization circuitry, quantization operations on the transformed residual block to generate a quantized transformed residual block. The method can further include generating, by a neural network, a recovered transform block including recovered transform coefficients for the quantized transformed residual block to reduce errors introduced by the quantization circuitry. In some embodiments, a first error between the recovered transform block and the transformed residual block can be smaller than a second error between the transformed residual block and a dequantized transformed residual block generated by performing inverse quantization operations on the quantized transformed residual block, where the first error and the second error are determined based on a cost function.

This Summary is provided merely for purposes of illustrating some embodiments to provide an understanding of the subject matter described herein. Accordingly, the above-described features are merely examples and should not be construed to narrow the scope or spirit of the subject matter in this disclosure Other features, embodiments, and advantages of this disclosure will become apparent from the following Detailed Description, Figures, and Claims.

### BRIEF DESCRIPTION OF THE DRAWINGS

Embodiments of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a block diagram of an electronic device including a codec, in accordance with some embodiments.

FIG. 2 is an example of the electronic device of FIG. 1, in accordance with some embodiments.

FIG. 3 is another example of the electronic device of FIG. 1, in accordance with some embodiments.

FIG. 4 is another example of the electronic device of FIG. 1, in accordance with some embodiments.

FIG. 5 is another example of the electronic device of FIG. 1, in accordance with some embodiments.

FIG. 6 is a schematic diagram of image processing circuitry including a codec, in accordance with some embodiments.

FIG. 7 is schematic diagram of a portion of the electronic device including a video encoding system, in accordance with some embodiments.

FIG. 8 is a schematic diagram of a portion of the electronic device including a video decoding system, in accordance with some embodiments.

FIGS. 9A-9B are schematic diagrams of a reconstruction block including a neural network that can be used as a portion of a codec in the electronic device, in accordance with some embodiments.

FIG. 10 is a schematic diagram showing various image blocks being processed by a neural network in a reconstruction block of a codec, in accordance with some embodiments.

FIG. 11 is a schematic diagram showing the process performed by a neural network in a reconstruction block of a codec, in accordance with some embodiments.

FIG. 12 is a schematic diagram showing the communication between an encoder and a decoder including reconstruction block having a neural network, in accordance with some embodiments.

FIG. 13 illustrates a process performed by a reconstruction block having a neural network in a codec, in accordance some embodiments.

### DETAILED DESCRIPTION

The following disclosure provides many different embodiments, or examples, for implementing different features of the provided subject matter. Specific examples of components and arrangements are described below to simplify the present disclosure. These are merely examples and are not intended to be limiting. In addition, the present disclosure repeats reference numerals and/or letters in the various examples. This repetition is for the purpose of simplicity and clarity and, unless indicated otherwise, does not in itself dictate a relationship between the various embodiments and/or configurations discussed.

A codec such as a video codec is a encoder/decoder system that compresses and decompresses video data or other kinds of data to improve data flow through networks or storage spaces. A codec can exploit spatial and temporal coherence in image or frame sequences of a video stream to achieve improved compression rates. A codec can compress a raw video format into a more manageable size. By reducing file sizes, codecs can deliver significant savings in data usage and storage costs. In addition, transmitting uncompressed files uses a lot of bandwidth while using a codec to compress and transmit files uses less bandwidth. Accordingly, codecs can deliver high-quality streaming at lower bitrates, offering better viewing experiences to end users.

In some embodiments, a single video file contains different kinds of data such as image data for the video frames, audio data for the sound, metadata like the title, and other elements like subtitles. Video encoding or compression can involve compressing the size of raw digital video files and turning them into a more efficient format. There can be two primary types of video compression: lossy and lossless. Lossy compression reduces the file size by eliminating data that might not significantly impact the perceived image quality. On the other hand, lossless compression preserves all the original data in the video file, maintaining original image quality but often at the expense of larger file sizes compared to lossy compression.

In some embodiments, a codec can use intraframe compression, also known as spatial compression, which compresses each frame in a video individually and looks for any redundancies to reduce data. For example, a blue sky has nearly identical pixel data, so a block of a uniform color can represent those areas to cut down on file size. In some embodiments, a codec can use interframe compression, also known as temporal compression, which uses a more complex technique to reduce file sizes. Instead of compressing each frame individually, interframe compression only encodes the differences in subsequent frames.

This disclosure relates to lossy video compression standards and techniques that may be implemented for various applications, such as streaming large quantities of video and image data. Some devices, however, may not have the bandwidth to transfer the large quantities of video data necessary for video streaming. Streaming applications over networks may have a variety of bitrate profiles corresponding to the resolution of the receiver devices (e.g., 1 megabit per second for low resolution, 4-5 megabits per second for high resolution, 10 megabits per second for higher resolution). The receiver or receiving device may modify video data sent to the device, depending on the bandwidth the receiver device has available. Video data may be sent in multiple streams that each correspond to different resolutions, and the receiver device may select a stream based on the acceptable device bandwidth. This may introduce latency into the video processing, as the receiver device may need to synchronize to stream based on available bandwidth, and may need to switch over from one stream to another depending on bandwidth available.

Embodiments herein provide various systems and methods for video compression, which can be used to reduce latency and inefficiencies in video streaming. Embodiments disclosed herein include partitioning video data into layers corresponding to different bandwidths that are sent to a receiver device as a single stream of image data. The sender device may determine the bandwidth of the receiver device, and may drop layers from the stream depending on the available bandwidth of the receiver device. This enables the receiver device to receive a single stream of data, encode the coefficients, a multiplexer device may then receive all the layers and sends the layers individually to a demultiplexer device that combines the layers into a single stream, and then a decoder may decode the single stream. This method enables real-time control of video data sent to a receiver device, and reduces latency due to the single stream approach of sending the layered data in a single stream.

Additionally, techniques, such as rate control, may enable the encoder to ensure a minimum compression ratio for image slices without affecting the quality of the encoded image slices. The encoder may set minimum quantization step to enable a minimum compression ratio to be set, and guarantee a certain image quality. The encoder may also determine a maximum slice size for the encoded images, and adjust the quantization step size to set the compression ratio to enable a high throughput. Moreover, the video encoder may utilize multiple counters for the header, luma, and chroma components during encoding for every partition of the slice of image data. The slice of Y′CbCr image data received by the video encoder may be partitioned into multiple layers. The video encoder may first encode the slice without partitioning, and then may utilize the multiple counters when encoding every partition. The counters may be able to keep track of the header, luma, and chroma bits utilized for every layer within the slice. The counters may start with a run and end with the last non-zero element within the layers. The encoded layers may then be assembled into a single slice before the layers are sent to a core for decoding. The header may be constructed based on all the layer headers, and the scanned coefficients may be concatenated for all layers for each component.

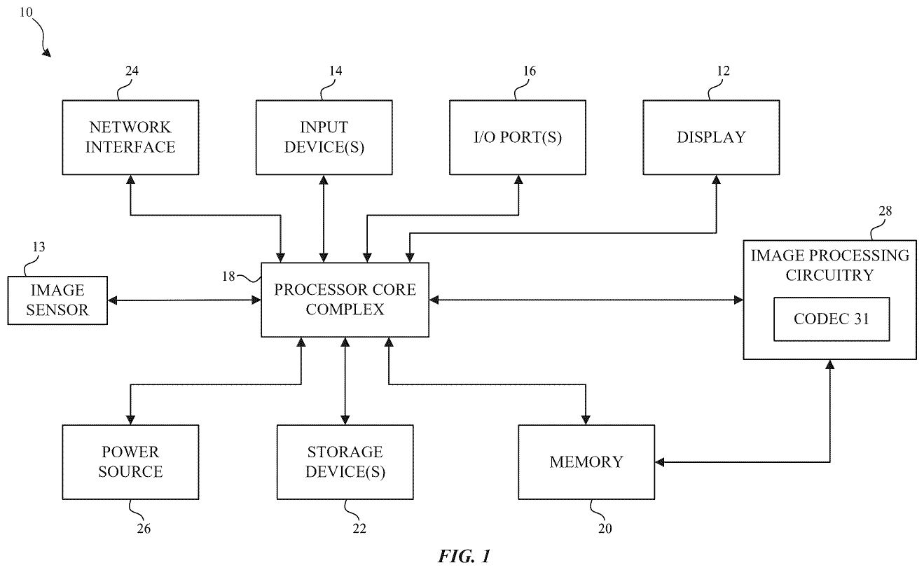

FIG. 1 shows an electronic device 10 including an electronic display 12 (e.g., display device) and a codec 31. As is described in more detail below, the electronic device 10 may be any suitable electronic device, such as a computer, a mobile phone, a portable media device, a tablet, a television, a virtual-reality headset, a vehicle dashboard, and the like. Thus, it should be noted that FIG. 1 is merely one example of a particular implementation and is intended to illustrate the types of components that may be present in electronic device 10.

The electronic display 12 may be any suitable electronic display. For example, the electronic display 12 may include a self-emissive pixel array having an array of one or more of self-emissive pixels. The electronic display 12 may include any suitable circuitry to drive the self-emissive pixels, including for example row driver and/or column drivers (e.g., display drivers). Each of the self-emissive pixels may include any suitable light emitting element, such as a Light-emitting diode (LED), one example of which is an organic light-emitting diode (OLED). However, any other suitable type of pixel, including non-self-emissive pixels (e.g., liquid crystal as used in liquid crystal displays (LCDs), digital micromirror devices (DMD) used in DMD displays) may also be used.

In the depicted embodiment, the electronic device 10 includes the electronic display 12, one or more input devices 14, an image sensor 13, one or more input/output (I/O) ports 16, a processor core complex 18 having one or more processor(s) or processor cores, local memory 20, a main memory storage device 22, a network interface 24, a power source 26 (e.g., power supply), and image processing circuitry 28. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the local memory 20 and the main memory storage device 22 may be included in a single component. The image processing circuitry 28 (e.g., a graphics processing unit) may be included in the processor core complex 18. The image processing circuitry 28 can include codec 31 that processes images and/or videos.

The processor core complex 18 may execute instruction stored in local memory 20 and/or the main memory storage device 22 to perform operations, such as generating and/or transmitting image data. As such, the processor core complex 18 may include one or more general purpose microprocessors, one or more application specific integrated circuits (ASICs), one or more field programmable logic arrays (FPGAs), or any combination thereof.

In addition to instructions, the local memory 20 and/or the main memory storage device 22 may store data to be processed by the processor core complex 18. Thus, the local memory 20 and/or the main memory storage device 22 may include one or more tangible, non-transitory, computer-readable mediums. For example, the local memory 20 may include random access memory (RAM) and the main memory storage device 22 may include read-only memory (ROM), rewritable non-volatile memory such as flash memory, hard drives, optical discs, and/or the like.

The network interface 24 may communicate data with another electronic device and/or a network. For example, the network interface 24 (e.g., a radio frequency system) may enable the electronic device 10 to communicatively couple to a personal area network (PAN), such as a Bluetooth network, a local area network (LAN), such as an 1622.11x Wi-Fi network, and/or a wide area network (WAN), such as a 4G or Long-Term Evolution (LTE) cellular network.

The processor core complex 18 is operably coupled to the power source 26. The power source 26 may provide electrical power to one or more components in the electronic device 10, such as the processor core complex 18 and/or the electronic display 12. Thus, the power source 26 may include any suitable source of energy, such as a rechargeable lithium polymer (Li-poly) battery and/or an alternating current (AC) power converter.

The processor core complex 18 is operably coupled with the one or more I/O ports 16. The I/O ports 16 may enable the electronic device 10 to interface with other electronic devices. For example, when a portable storage device is connected, the I/O port 16 may enable the processor core complex 18 to communicate data with the portable storage device.

The electronic device 10 is also operably coupled with the one or more input devices 14. The input device 14 may enable user interaction with the electronic device 10, for example, by receiving user inputs via a button, a keyboard, a mouse, a trackpad, and/or the like. The input device 14 may include touch-sensing components in the electronic display 12. The touch-sensing components may receive user inputs by detecting occurrence and/or position of an object touching the surface of the electronic display 12. In some embodiments, image sensor 13 may be a part of input device 14.

In addition to enabling user inputs, the electronic display 12 may include one or more display panels. Each display panel may be a separate display device or one or more display panels may be combined into the same device. The electronic display 12 may control light emission from the display pixels to present visual representations of information, such as a graphical user interface (GUI) of an operating system, an application interface, a still image, or video content, by displaying frames based on corresponding image data. As depicted, the electronic display 12 is operably coupled to the processor core complex 18 and the image processing circuitry 28. In this manner, the electronic display 12 may display frames based on image data generated by the processor core complex 18 and/or the image processing circuitry 28. Additionally or alternatively, the electronic display 12 may display frames based on image data received via the network interface 24, an input device 14, an I/O port 16, or the like.

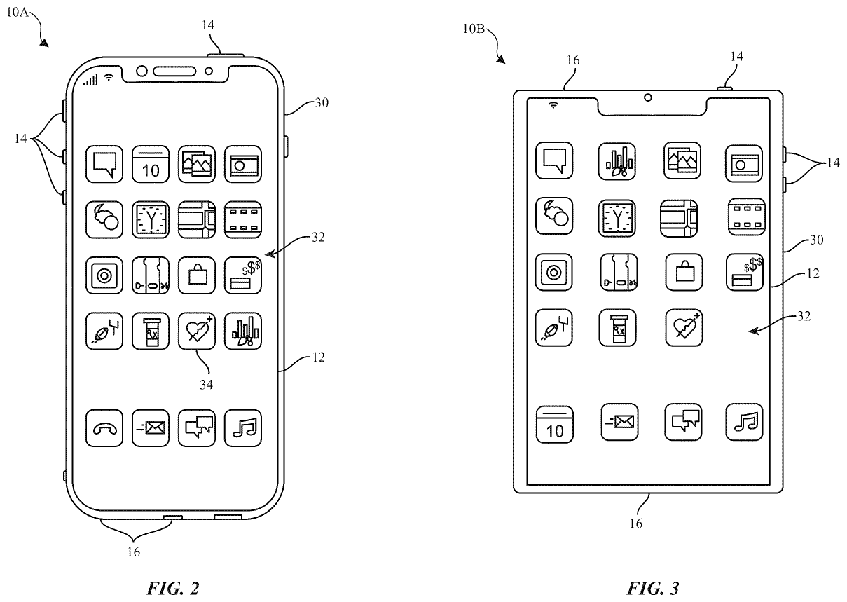

As described above, the electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, and/or the like. For illustrative purposes, the handheld device 10A may be a smart phone, such as any IPHONE® model available from Apple Inc.

The handheld device 10A includes an enclosure 30 (e.g., housing). The enclosure 30 may protect interior components from physical damage and/or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. The I/O ports 16 may be accessed through openings in the enclosure 30 and may include, for example, an audio jack to connect to external devices.

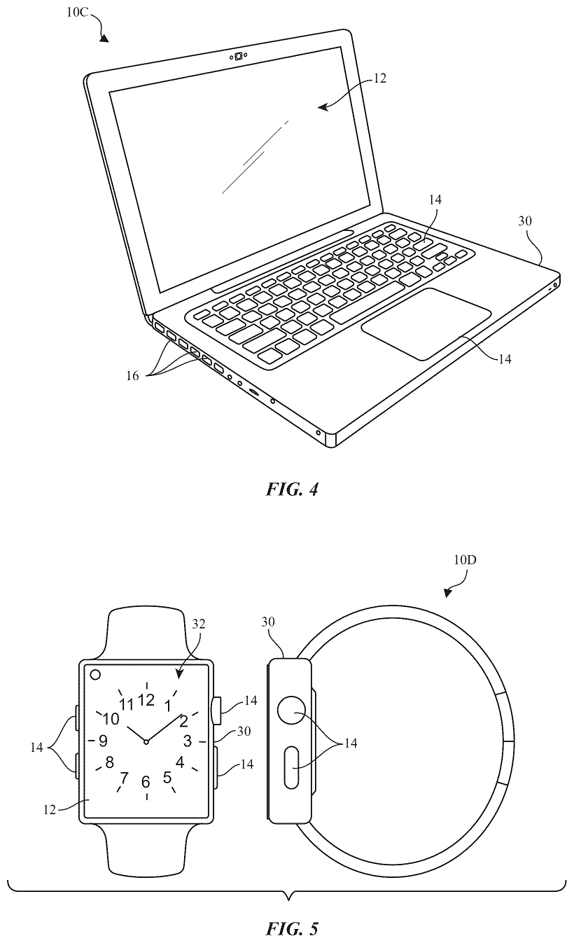

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

The electronic device 10 may initially receive video stream data corresponding to lossy video compression standards. The video stream data may be received and encoded by a video encoder of the electronic device 10. The video stream data may include data that has been partitioned into layers corresponding to available device bandwidth. The video encoder may encode slices of the video data using data partitioning to encode the layers of video stream data received. In some embodiments, the image processing circuitry 28 can include the codec 31 that processes images and/or videos, performs encoding (e.g., high-throughput encoding) and/or decoding functionality, communicates with one or more displays, reads and writes compressed data and/or bitstreams, and the like.

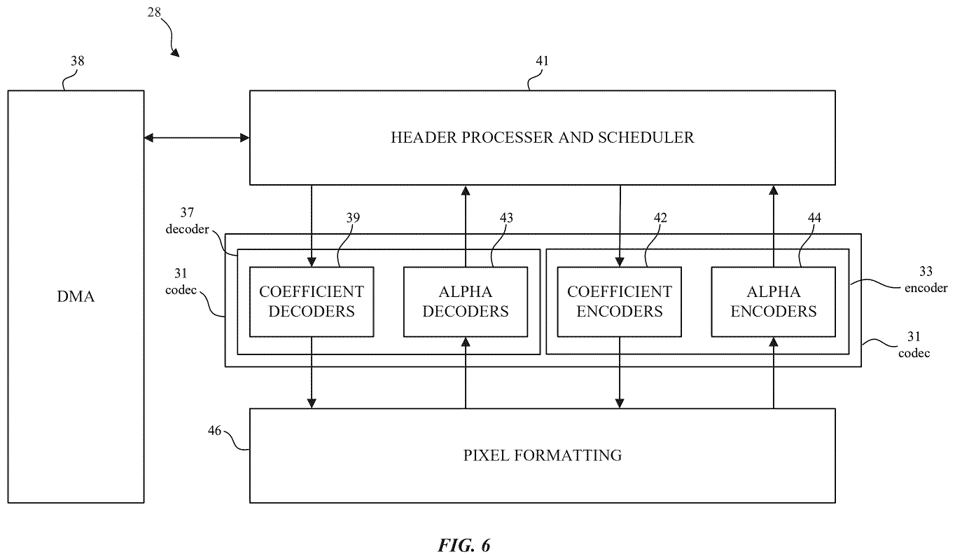

FIG. 6 is a schematic diagram of image processing circuitry 28, in accordance with some embodiments. The image processing circuitry 28 may in some embodiments process images and/or videos, perform high throughput encoding and decoding functionality by codec 31, communicate with one or more displays, read and write compressed data and/or bitstreams, and the like. The image processing circuitry 28 includes a header processor and scheduler 41 that may schedule video data received from the direct memory access (DMA) 38 to a decoder 37 within codec 31. In some embodiments, decoder 37 can include multiple coefficient decoders 39 and multiple alpha decoders 43. The DMA 38 may also receive encoded image data from an encoder 33 within codec 31. In some embodiments, encoder 33 can include multiple coefficient encoders 42 and the multiple alpha encoders 44. The pixel formatting component 46 may receive pixel data from the multiple coefficient decoders 39 and the multiple alpha decoders 43 and send the pixel data to the multiple coefficient encoders 42 and the multiple alpha encoders 44. In some embodiments there may be 16 coefficient decoders 39 and four alpha decoders 43, and 16 coefficient encoders 42 and four alpha encoders 44. It should be understood that any suitable number of coefficient encoders/decoders and alpha encoders/decoders may be implemented.

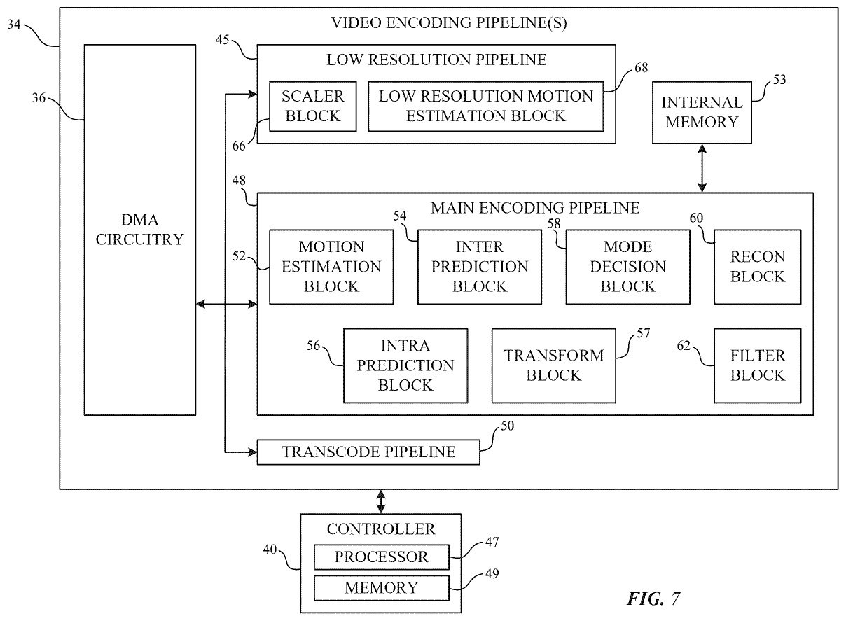

FIG. 7 is schematic diagram of a portion of electronic device 10 including a video encoding system 34, in accordance with an embodiment. In some embodiments, video encoding system 34 may be implemented via circuitry, such as encoder 33 within image processing circuitry 28, which can be packaged as a system-on-chip (SoC). Additionally or alternatively, video encoding system 34 may be included in the processor core complex 18, a timing controller (TCON) in the electronic display 12, one or more other processing units, other processing circuitry, or any combination thereof.

The video encoding system 34 may be communicatively coupled to a controller 40. The controller 40 may generally control operation of the video encoding system 34. Although depicted as a single controller 40, in other embodiments, one or more separate controllers 40 may be used to control operation of the video encoding system 34. Additionally, in some embodiments, the controller 40 may be implemented in the video encoding system 34, for example, as a dedicated video encoding controller.

The controller 40 may include a controller processor 47 and controller memory 49. In some embodiments, the controller processor 47 may execute instructions and/or process data stored in the controller memory 49 to control operation of the video encoding system 34. In other embodiments, the controller processor 47 may be hardwired with instructions that control operation of the video encoding system 34. Additionally, in some embodiments, the controller processor 47 may be included in the processor core complex 18 and/or separate processing circuitry (e.g., in the electronic display) and the controller memory 49 may be included in local memory 20, main memory storage device 22, and/or a separate, tangible, non-transitory computer-readable medium (e.g., in the electronic display).

The video encoding system 34 includes DMA circuitry 36. In some embodiments, the DMA circuitry 36 may communicatively couple the video encoding system 34 to an image source, such as external memory that stores source image data, for example, generated by the image sensor 13 or received via the network interface 24 or the I/O ports 16.

To facilitate generating encoded image data, the video encoding system 34 may include multiple parallel pipelines. For example, in the depicted embodiment, the video encoding system 34 includes a low resolution pipeline 45, a main encoding pipeline 48, and a transcode pipeline 50. The main encoding pipeline 48 may encode source image data using prediction techniques (e.g., inter prediction techniques or intra prediction techniques), and the transcode pipeline 50 may subsequently entropy encode syntax elements that indicate encoding parameters (e.g., quantization coefficient, inter prediction mode, and/or intra prediction mode) used to prediction encode the image data.

To facilitate prediction encoding source image data, the main encoding pipeline 48 may perform various functions. To simplify discussion, the functions are divided between various blocks (e.g., circuitry or modules) in the main encoding pipeline 48. In the depicted embodiment, the main encoding pipeline 48 includes a motion estimation block 52, an inter prediction block 54, an intra prediction block 56, a transform block 57, a mode decision block 58, a reconstruction block 60, and a filter block 62.

The motion estimation block 52 is communicatively coupled to the DMA circuitry 36. In this manner, the motion estimation block 52 may receive source image data via the DMA circuitry 36, which may include a luma component (e.g., Y) and two chroma components (e.g., Cr and Cb). In some embodiments, the motion estimation block 52 may process one coding unit, including one luma coding block and two chroma coding blocks, at a time. As used herein, a “luma coding block” is intended to describe the luma component of a coding unit and a “chroma coding block” is intended to describe a chroma component of a coding unit.

A luma coding block may be the same resolution as the coding unit. On the other hand, the chroma coding blocks may vary in resolution based on chroma sampling format. For example, using a 4:4:4 sampling format, the chroma coding blocks may be the same resolution as the coding unit. However, the chroma coding blocks may be half (e.g., half resolution in the horizontal direction) the resolution of the coding unit when a 4:2:2 sampling format is used and a quarter (e.g., half resolution in the horizontal direction and half resolution in the vertical direction) the resolution of the coding unit when a 4:2:0 sampling format is used.

As described above, a coding unit may include one or more prediction units, which may each be encoded using the same prediction technique, but different prediction modes. Each prediction unit may include one luma prediction block and two chroma prediction blocks. As used herein, a “luma prediction block” is intended to describe the luma component of a prediction unit and a “chroma prediction block” is intended to describe a chroma component of the prediction unit. In some embodiments, the luma prediction block may be the same resolution as the prediction unit. On the other hand, similar to the chroma coding blocks, the chroma prediction blocks may vary in resolution based on chroma sampling format.

Based at least in part on the one or more luma prediction blocks, the motion estimation block 52 may determine candidate inter prediction modes that can be used to encode a prediction unit. An inter prediction mode may include a motion vector and a reference index to indicate location (e.g., spatial position and temporal position) of a reference sample relative to a prediction unit. More specifically, the reference index may indicate display order of a reference image frame corresponding with the reference sample relative to a current image frame corresponding with the prediction unit. Additionally, the motion vector may indicate position of the reference sample in the reference image frame relative to position of the prediction unit in the current image frame.

To determine a candidate inter prediction mode, the motion estimation block 52 may search reconstructed luma image data, which may be previously generated by the reconstruction block 60 and stored in internal memory 53 (e.g., reference memory) of the video encoding system 34. For example, the motion estimation block 52 may determine a reference sample for a prediction unit by comparing its luma prediction block to the luma of reconstructed image data. In some embodiments, the motion estimation block 52 may determine how closely a prediction unit and a reference sample match based on a match metric. In some embodiments, the match metric may be the sum of absolute difference (SAD) between a luma prediction block of the prediction unit and luma of the reference sample. Additionally or alternatively, the match metric may be the sum of absolute transformed difference (SATD) between the luma prediction block and luma of the reference sample. When the match metric is above a match threshold, the motion estimation block 52 may determine that the reference sample and the prediction unit do not closely match. On the other hand, when the match metric is below the match threshold, the motion estimation block 52 may determine that the reference sample and the prediction unit are similar.

After a reference sample that sufficiently matches the prediction unit is determined, the motion estimation block 52 may determine location of the reference sample relative to the prediction unit. For example, the motion estimation block 52 may determine a reference index to indicate a reference image frame, which contains the reference sample, relative to a current image frame, which contains the prediction unit. Additionally, the motion estimation block 52 may determine a motion vector to indicate position of the reference sample in the reference frame relative to position of the prediction unit in the current frame. In some embodiments, the motion vector may be expressed as (mvX, mvY), where mvX is horizontal offset and mvY is a vertical offset between the prediction unit and the reference sample. The values of the horizontal and vertical offsets may also be referred to as x-components and y-components, respectively.

In this manner, the motion estimation block 52 may determine candidate inter prediction modes (e.g., reference index and motion vector) for one or more prediction units in the coding unit. The motion estimation block 52 may then input candidate inter prediction modes to the inter prediction block 54. Based at least in part on the candidate inter prediction modes, the inter prediction block 54 may determine luma prediction samples (e.g., predictions of a prediction unit).

The inter prediction block 54 may determine a luma prediction sample by applying motion compensation to a reference sample indicated by a candidate inter prediction mode. For example, the inter prediction block 54 may apply motion compensation by determining luma of the reference sample at fractional (e.g., quarter or half) pixel positions. The inter prediction block 54 may then input the luma prediction sample and corresponding candidate inter prediction mode to the mode decision block 58 for consideration. In some embodiments, the inter prediction block 54 may sort the candidate inter prediction modes based on associated mode cost and input only a specific number to the mode decision block 58.

The mode decision block 58 may also consider one or more candidate intra predictions modes and corresponding luma prediction samples output by the intra prediction block 56. The main encoding pipeline 48 may be capable of implementing multiple (e.g., 13, 17, 25, 29, 35, 38, or 43) different intra prediction modes to generate luma prediction samples based on adjacent pixel image data. Thus, in some embodiments, the intra prediction block 56 may determine a candidate intra prediction mode and corresponding luma prediction sample for a prediction unit based at least in part on luma of reconstructed image data for adjacent (e.g., top, top right, left, or bottom left) pixels, which may be generated by the reconstruction block 60.

For example, utilizing a vertical prediction mode, the intra prediction block 56 may set each column of a luma prediction sample equal to reconstructed luma of a pixel directly above the column. Additionally, utilizing a DC prediction mode, the intra prediction block 56 may set a luma prediction sample equal to an average of reconstructed luma of pixels adjacent the prediction sample. The intra prediction block 56 may then input candidate intra prediction modes and corresponding luma prediction samples to the mode decision block 58 for consideration. In some embodiments, the intra prediction block 56 may sort the candidate intra prediction modes based on associated mode cost and input only a specific number to the mode decision block 58.

The mode decision block 58 may determine encoding parameters to be used to encode the source image data (e.g., a coding unit). In some embodiments, the encoding parameters for a coding unit may include prediction technique (e.g., intra prediction techniques or inter prediction techniques) for the coding unit, number of prediction units in the coding unit, size of the prediction units, prediction mode (e.g., intra prediction modes or inter prediction modes) for each of the prediction units, number of transform units in the coding unit, size of the transform units, whether to split the coding unit into smaller coding units, or any combination thereof.

To facilitate determining the encoding parameters, the mode decision block 58 may determine whether the image frame is an I-frame, a P-frame, or a B-frame. In I-frames, source image data is encoded only by referencing other image data used to display the same image frame. Accordingly, when the image frame is an I-frame, the mode decision block 58 may determine that each coding unit in the image frame may be prediction encoded using intra prediction techniques.

On the other hand, in a P-frame or B-frame, source image data may be encoded by referencing image data used to display the same image frame and/or a different image frames. More specifically, in a P-frame, source image data may be encoding by referencing image data associated with a previously coded or transmitted image frame. Additionally, in a B-frame, source image data may be encoded by referencing image data used to code two previous image frames. More specifically, with a B-frame, a prediction sample may be generated based on prediction samples from two previously coded frames; the two frames may be different from one another or the same as one another. Accordingly, when the image frame is a P-frame or a B-frame, the mode decision block 58 may determine that each coding unit in the image frame may be prediction encoded using either intra techniques or inter techniques.

Although using the same prediction technique, the configuration of luma prediction blocks in a coding unit may vary. For example, the coding unit may include a variable number of luma prediction blocks at variable locations within the coding unit, which each uses a different prediction mode. As used herein, a “prediction mode configuration” is intended to describe the number, size, location, and prediction mode of luma prediction blocks in a coding unit. Thus, the mode decision block 58 may determine a candidate inter prediction mode configuration using one or more of the candidate inter prediction modes received from the inter prediction block 54. Additionally, the mode decision block 58 may determine a candidate intra prediction mode configuration using one or more of the candidate intra prediction modes received from the intra prediction block 56.

Since a coding unit may utilize the same prediction technique, the mode decision block 58 may determine prediction technique for the coding unit by comparing rate-distortion metrics (e.g., costs) associated with the candidate prediction mode configurations and/or a skip mode. In some embodiments, the rate-distortion metric may be determined by summing a first product obtained by multiplying an estimated rate that indicates number of bits expected to be used to indicate encoding parameters and a first weighting factor for the estimated rate and a second product obtained by multiplying a distortion metric (e.g., sum of squared difference) resulting from the encoding parameters and a second weighting factor for the distortion metric. The first weighting factor may be a Lagrangian multiplier, and the first weighting factor may depend on a quantization parameter associated with image data being processed.

The distortion metric may indicate amount of distortion in decoded image data expected to be caused by implementing a prediction mode configuration. Accordingly, in some embodiments, the distortion metric may be a sum of squared difference (SSD) between a luma coding block (e.g., source image data) and reconstructed luma image data received from the reconstruction block 60. Additionally or alternatively, the distortion metric may be a sum of absolute transformed difference (SATD) between the luma coding block and reconstructed luma image data received from the reconstruction block 60.

In some embodiments, prediction residuals (e.g., differences between source image data and prediction sample) resulting in a coding unit may be transformed as one or more transform units. In some embodiments, a prediction residual may be referred to as a “residual signal.” As used herein, a “transform unit” is intended to describe a sample within a coding unit that is transformed together by transform block 57. In some embodiments, a coding unit may include a single transform unit. In other embodiments, the coding unit may be divided into multiple transform units, which is each separately transformed by transform block 57.

Additionally, the estimated rate for an intra prediction mode configuration may include expected number of bits used to indicate intra prediction technique (e.g., coding unit overhead), expected number of bits used to indicate intra prediction mode, expected number of bits used to indicate a prediction residual (e.g., source image data-prediction sample), and expected number of bits used to indicate a transform unit split. On the other hand, the estimated rate for an inter prediction mode configuration may include expected number of bits used to indicate inter prediction technique, expected number of bits used to indicate a motion vector (e.g., motion vector difference), and expected number of bits used to indicate a transform unit split. Additionally, the estimated rate of the skip mode may include number of bits expected to be used to indicate the coding unit when prediction encoding is skipped.

In embodiments where a rate-distortion metric is used, the mode decision block 58 may select a prediction mode configuration or skip mode with the lowest associated rate-distortion metric for a coding unit. In this manner, the mode decision block 58 may determine encoding parameters for a coding unit, which may include prediction technique (e.g., intra prediction techniques or inter prediction techniques) for the coding unit, number of prediction units in the coding unit, size of the prediction units, prediction mode (e.g., intra prediction modes or inter prediction modes) for each of the prediction unit, number of transform units in the coding block, size of the transform units, whether to split the coding unit into smaller coding units, or any combination thereof.

To facilitate improving perceived image quality resulting from decoded image data, the main encoding pipeline 48 may then mirror decoding of encoded image data. To facilitate, the mode decision block 58 may output the encoding parameters and/or luma prediction samples to the reconstruction block 60. Based on the encoding parameters and reconstructed image data associated with one or more adjacent blocks of image data, the reconstruction block 60 may reconstruct image data.

More specifically, the reconstruction block 60 may generate the luma component of reconstructed image data. In some embodiments, the reconstruction block 60 may generate reconstructed luma image data by subtracting the luma prediction sample from luma of the source image data to determine a luma prediction residual. The reconstruction block 60 may then divide the luma prediction residuals into luma transform blocks as determined by the mode decision block 58, perform a forward transform and quantization on each of the luma transform blocks, and perform an inverse transform and quantization on each of the luma transform blocks to determine a reconstructed luma prediction residual. The reconstruction block 60 may then add the reconstructed luma prediction residual to the luma prediction sample to determine reconstructed luma image data. As described above, the reconstructed luma image data may then be fed back for use in other blocks in the main encoding pipeline 48, for example, via storage in internal memory 53 of the main encoding pipeline 48. Additionally, the reconstructed luma image data may be output to the filter block 62.

The reconstruction block 60 may also generate both chroma components of reconstructed image data. In some embodiments, chroma reconstruction may be dependent on sampling format. For example, when luma and chroma are sampled at the same resolution (e.g., 4:4:4 sampling format), the reconstruction block 60 may utilize the same encoding parameters as used to reconstruct luma image data. In such embodiments, for each chroma component, the reconstruction block 60 may generate a chroma prediction sample by applying the prediction mode configuration determined by the mode decision block 58 to adjacent pixel image data.

The reconstruction block 60 may then subtract the chroma prediction sample from chroma of the source image data to determine a chroma prediction residual. Additionally, the reconstruction block 60 may divide the chroma prediction residual into chroma transform blocks as determined by the mode decision block 58, perform a forward transform and quantization on each of the chroma transform blocks, and perform an inverse transform and quantization on each of the chroma transform blocks to determine a reconstructed chroma prediction residual. The chroma reconstruction block may then add the reconstructed chroma prediction residual to the chroma prediction sample to determine reconstructed chroma image data, which may be input to the filter block 62.

However, in other embodiments, chroma sampling resolution may vary from luma sampling resolution, for example when a 4:2:2 or 4:2:0 sampling format is used. In such embodiments, encoding parameters determined by the mode decision block 58 may be scaled. For example, when the 4:2:2 sampling format is used, size of chroma prediction blocks may be scaled in half horizontally from the size of prediction units determined in the mode decision block 58. Additionally, when the 4:2:0 sampling format is used, size of chroma prediction blocks may be scaled in half vertically and horizontally from the size of prediction units determined in the mode decision block 58. In a similar manner, a motion vector determined by the mode decision block 58 may be scaled for use with chroma prediction blocks.

To improve quality of decoded image data, the filter block 62 may filter the reconstructed image data (e.g., reconstructed chroma image data and/or reconstructed luma image data). In some embodiments, the filter block 62 may perform deblocking and/or sample adaptive offset (SAO) functions. For example, the filter block 62 may perform deblocking on the reconstructed image data to reduce perceivability of blocking artifacts that may be introduced. Additionally, the filter block 62 may perform a sample adaptive offset function by adding offsets to portions of the reconstructed image data.

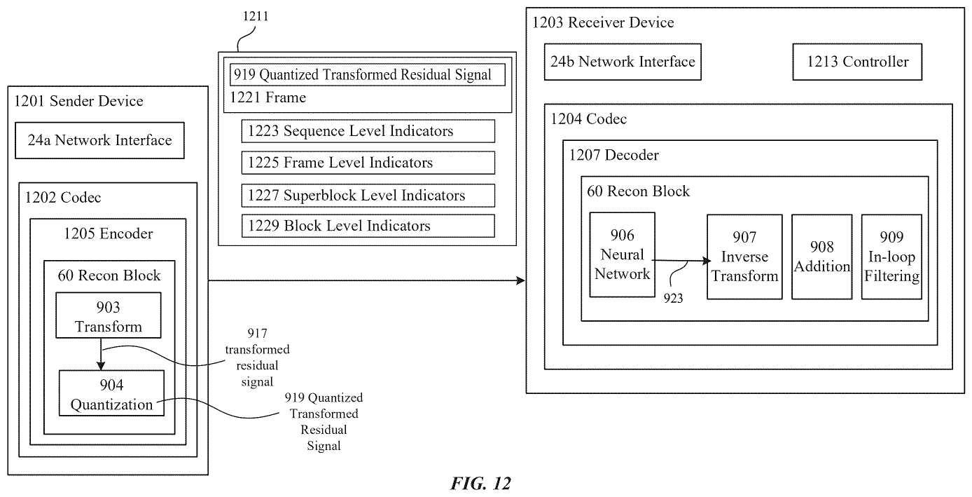

To enable decoding, encoding parameters used to generate encoded image data may be communicated to a decoding device. In some embodiments, encoding parameters may be used by an encoder in a sender device, and the decoding device can be a decoder in a receiver device, as shown in FIG. 12. In some embodiments, the encoding parameters may include the encoding parameters determined by the mode decision block 58 (e.g., prediction unit configuration and/or transform unit configuration), encoding parameters used by the reconstruction block 60 (e.g., quantization coefficients), and encoding parameters used by the filter block 62. To facilitate communication, the encoding parameters may be expressed as syntax elements. For example, a first syntax element may indicate a prediction mode (e.g., inter prediction mode or intra prediction mode), a second syntax element may indicate a quantization coefficient, a third syntax element may indicate configuration of prediction units, and a fourth syntax element may indicate configuration of transform units.

The transcode pipeline 50 may then convert a bin stream, which is representative of syntax elements generated by the main encoding pipeline 48, to a bit stream with one or more syntax elements represented by a fractional number of bits. In some embodiments, the transcode pipeline 50 may compress bins from the bin stream into bits using arithmetic coding. To facilitate arithmetic coding, the transcode pipeline 50 may determine a context model for a bin, which indicates probability of the bin being a “1” or “0,” based on previous bins. Based on the probability of the bin, the transcode pipeline 50 may divide a range into two sub-ranges. The transcode pipeline 50 may then determine an encoded bit such that it falls within one of two sub-ranges to select the actual value of the bin. In this manner, multiple bins may be represented by a single bit, thereby improving encoding efficiency (e.g., reduction in size of source image data). After entropy encoding, the transcode pipeline 50, may transmit the encoded image data to the output 38 for transmission, storage, and/or display.

Additionally, the video encoding system 34 may be communicatively coupled to an output. In this manner, the video encoding system 34 may output encoded (e.g., compressed) image data to such an output, for example, for storage and/or transmission. Thus, in some embodiments, the local memory 20, the main memory storage device 22, the network interface 24, the I/O ports 16, the controller memory 49, or any combination thereof may serve as an output.

As described above, the duration provided for encoding image data may be limited, particularly to enable real-time or near real-time display and/or transmission. To improve operational efficiency (e.g., operating duration and/or power consumption) of the main encoding pipeline 48, the low resolution pipeline 45 may include a scaler block 66 and a low resolution motion estimation (ME) block 68. The scaler block 66 may receive image data and downscale the image data (e.g., a coding unit) to generate low-resolution image data. For example, the scaler block 66 may downscale a 32×32 coding unit to one-sixteenth resolution to generate an 8×8 downscaled coding unit. In other embodiments, such as embodiments in which pre-processing circuitry generates image data (e.g., low-resolution image data) from source image data, the low resolution pipeline may not include the scaler block 66, or the scaler block 66 may not be utilized to downscale image data.

The low resolution motion estimation block 68 may improve operational efficiency by initializing the motion estimation block 52 with candidate inter prediction modes, which may facilitate reducing searches performed by the motion estimation block 52. Additionally, the low resolution motion estimation block 68 may improve operational efficiency by generating global motion statistics that may be utilized by the motion estimation block 52 to determine a global motion vector.

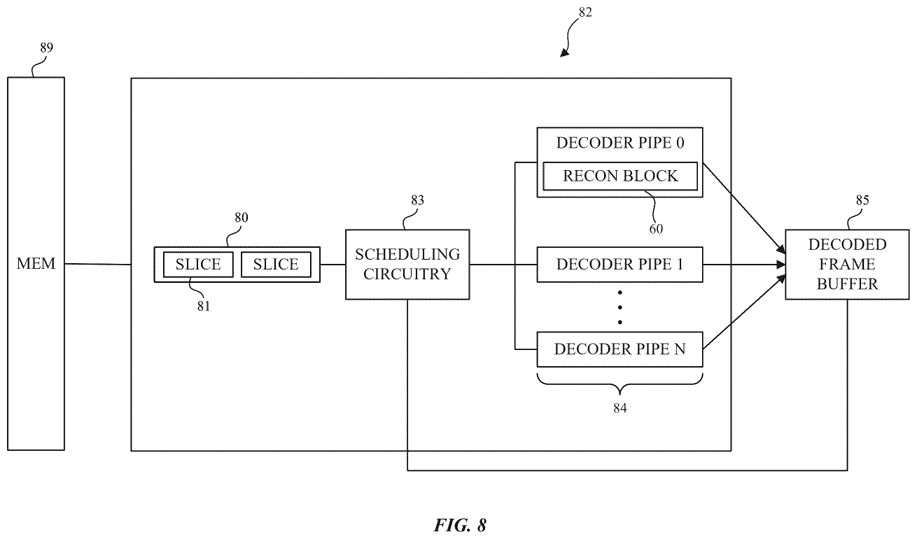

FIG. 8 is a schematic diagram of a portion of electronic device 10 including a video decoder circuitry 82, which can be a part of decoder 37 included within image processing circuitry 28, in accordance with an embodiment. In some embodiments, decoder circuitry 82 can include multiple decoder pipelines 84. The image processing circuitry 28 may include scheduling circuitry 83 that is able to schedule each of the compressed slices 81 of the bitstream 80 to one or more of the multiple decoder pipelines 84.

The multiple decoder pipelines 84 may receive compressed slices 81 from a memory 89 that are in the bitstream 80 and process each compressed slice 81 in the bitstream 80 to reconstruct the image frame from data of the encoded bitstream 80. The decoder pipelines 84 may be able to process the encoded bitstream data and produce decompressed frame data as a result of completing the decoding process. The number of decoder pipelines 84 may be any suitable number for efficient processing of the bitstream 80. For example, the number of decoder pipelines 84 may be 16 (e.g., decoder 0-15) or any other suitable number.

The decoder pipelines 84 may complete an entropy decoding process that is applied to the compressed video components of the slice 81 to produce arrays of scanned color component quantized discrete cosine transform (DCT) coefficients. Additionally, the bitstream 80 may also include an encoded alpha channel, and the entropy decoding may produce an array of raster-scanned alpha values. The one or more compressed slices 81 received at the multiple decoders pipelines 84 may include entropy-coded arrays of scanned quantized DCT coefficients that correspond to each luma and chroma color component (e.g., Y′, Cb, Cr) that is included in the image frame. The quantized DC coefficients may be encoded differentially and the AC coefficients may be run-length encoded. Both the DC coefficients and the AC coefficients utilize variable-length coding (VLC) and are encoded using context adaptation. This results in some DC/AC coefficients being shorter in length and some being longer in length, such that processing time variability is present due to differences during context adaptation. This leads some portions of the bitstream 80 to include smaller DC/AC coefficients due to VLC that may process faster than other portions of the bitstream 80 due to variability in the DC/AC coefficients in the compressed slice 81.

The multiple decoder pipelines 84 may carry out multiple processing operations to reconstruct the image from the compressed slices 81 in the bitstream 80. In some embodiments, one or more decoder pipelines 84 can include a reconstruction block 60 to perform functions described herein. The multiple decoder pipelines 84 may include an entropy decoding process, as discussed above that is applied to video components of the compressed slice 81. The entropy decoding produces arrays of scanned color component quantized DCT coefficients and may also produce an array of raster-scanned alpha values if the bitstream 80 includes an encoded alpha channel. The decoding process may then apply an inverse scanning process to each of the scanned color component quantized DCT coefficients to produce blocks of color component DCT coefficients. The decoding process may then include an inverse quantization process that enables each of the color component quantized DCT coefficients blocks to produce blocks of color component DCT coefficients. The decoding process may conclude with each of the reconstructed color component values being converted to integral samples (e.g., pixel component samples) of desired bit depth and sending the integral samples from the decoder pipeline 84 to the decoded frame buffer 85.

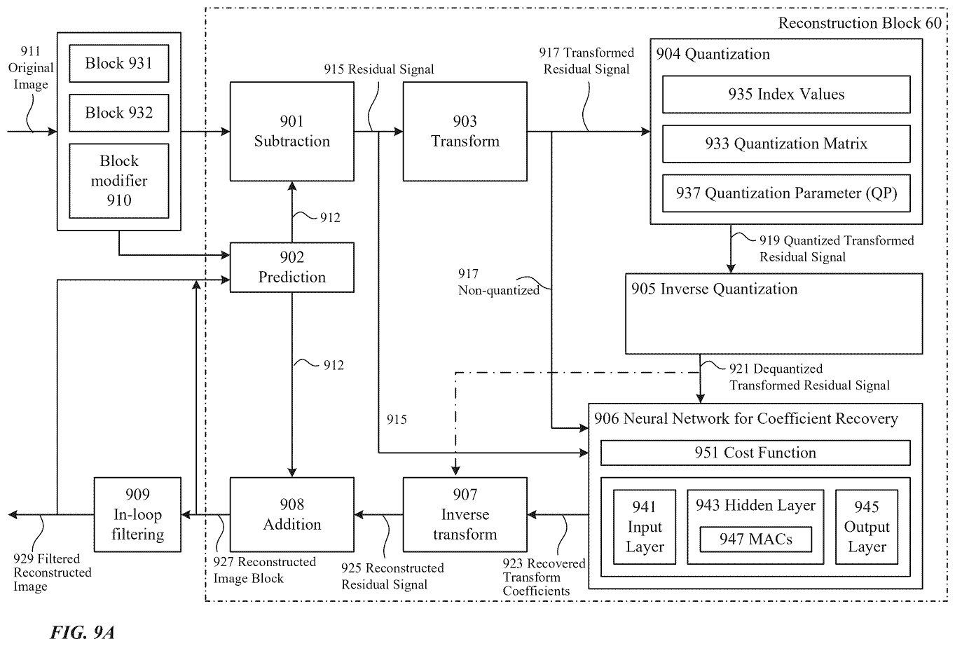

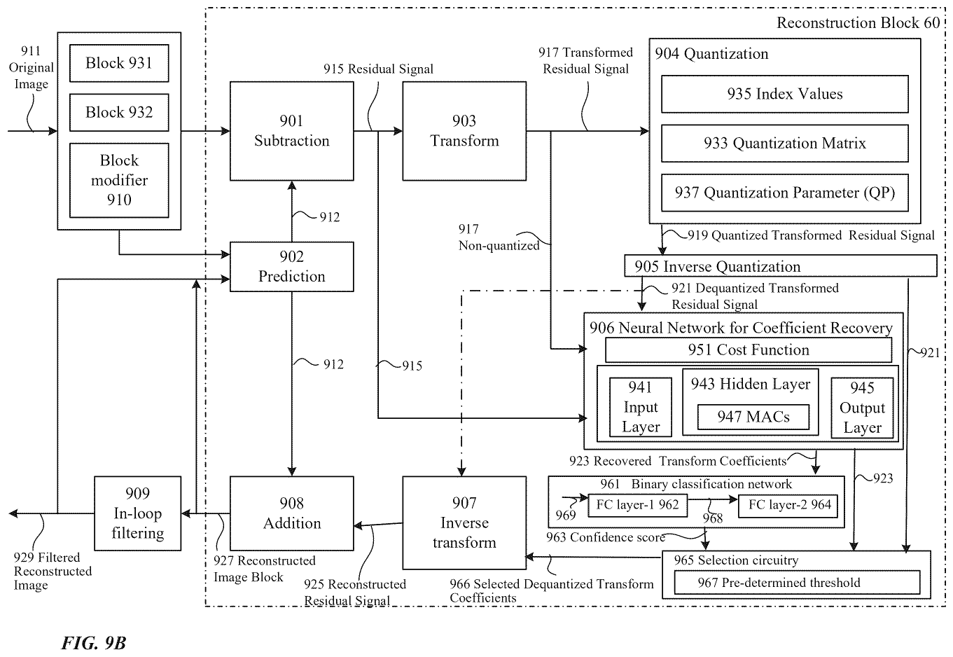

FIGS. 9A-9B are schematic diagrams of the reconstruction block 60 including a neural network 906 that can be used as a portion of the codec 31 of the electronic device 10, in accordance with some embodiments. In some embodiments, the reconstruction block 60 including neural network 906 can be used in encoder 33 or decoder 37 of codec 31 for video compression schemes, as shown in FIGS. 1, 6, 7, and 8. FIG. 9A illustrates an embodiment of the reconstruction block 60 including neural network 906. FIG. 9B illustrates another embodiment of the reconstruction block 60 including neural network 60.

In some embodiments, reconstruction block 60 can include a prediction circuitry 902, a subtraction circuitry 901, a transform circuitry 903, a quantization circuitry 904, an inverse quantization circuitry 905, the neural network 906, an inverse transform circuitry 907, an addition circuitry 908, an in-loop filtering circuitry 909, among other circuitry and components. In some embodiments, as shown in FIG. 9B, reconstruction block 60 can include a binary classification network 961 and a selection circuitry 965.

In some embodiments, components of reconstruction block 60, such as the various circuitries shown in FIGS. 9A-9B, can be implemented as a part of a VLSI hardware data path implementation. In some embodiments, the various circuitries described herein for reconstruction block 60 can be implemented by software operated by processor core complex 18 having one or more processor(s) or processor cores, or a combination of hardware and software.

In some embodiments, reconstruction block 60 can receive an image 911, which is processed block by block, such as input block 931 and input block 932. In some embodiments, an input block, e.g., input block 931 or input block 932, can include individual data organized into a two-dimensional format. For example, input block 931 can include multiple pixels organized into a two-dimensional matrix format, e.g., 3*3 size, 5*5 size, or any other suitable matrix format. In some embodiments, a block of data can refer to multiple data organized in a two-dimensional matrix format. In some embodiments, data for the image 911 can be included in data for a frame of a video stream, such as the video stream 80. In some embodiments, the multiple input blocks, such as input block 931 and input block 932, can be non-overlapping input blocks of the image 911. In some embodiments, an input block or any other block generated or processed by reconstruction block 60 can include a matrix of coefficients. For an input block, such as input block 931, reconstruction block 60 can generate a reconstructed image block 927, which can be a matrix of coefficients as well. In some embodiments, input block 931 or input block 932 can be a coding unit, a prediction unit, a transform unit, a quantization block, or other data unit processed by the reconstruction block 60.

In some embodiments, prediction circuitry 902 can receive the input block 931 of the image 911 and perform a prediction operation to generate a predicted block 912 for the input block 931. In addition, prediction circuitry 902 can further provide the predicted block 912 to the subtraction circuitry 901. Afterwards, the subtraction circuitry 901 can subtract the predicted block 912 from the input block 931 to generate a residual signal 915. In some embodiments, residual signal 915 can be referred as a residual block. In some embodiments, the residual signal 915 can be referred to as a prediction error signal since it represents an error between the predicted block 912 and the input block 931. In addition, transform circuitry 903 can perform a transform on residual signal 915 to generate the transformed residual signal 917, which can be a transformed residual block. In some embodiments, the transformed residual signal 917 can be referred to as the transformed coefficients. Accordingly, transformed residual signal 917 can include non-quantized transformed residual signal. Moreover, the quantization circuitry 904 can perform quantization operations on the transformed residual signal 917 to generate a quantized transformed residual signal 919, which can be a quantized transformed residual block. In some embodiments, the quantization circuitry 904 can be referred to as a quantizer, a quantization unit, a quantization module, or some other circuit performing quantization operations. In some embodiments, the inverse quantization circuitry 905 can perform inverse quantization operations and generate a dequantized transformed residual signal 921, which can be a dequantized transformed residual block, a dequantized signal, or dequantized coefficients. In some embodiments, the dequantized transformed residual signal 921 can be referred to as reconstructed transform coefficients since it is obtained by reconstruction from the quantization using dequantization or inverse quantization operations, while the inverse quantization circuitry 905 can be referred to as a dequantizer.

Furthermore, the inverse transform circuitry 907 can perform inverse transform operations on the dequantized transformed residual signal 921 received from the inverse quantization circuitry 905 to generate a reconstructed residue signal 925, when the dequantized transformed residual signal 921 is provided to the inverse transform circuitry 907 as illustrated in the dashed line between the two circuitries shown in FIGS. 9A-9B. In some embodiments, the inverse transform circuitry 907 can be referred to as an inverse transformer. In some embodiments, input to the inverse transform circuitry 907 can include the dequantized transformed residual signal 921. In some embodiments, addition circuitry 908 can add the reconstructed residue signal 925 to predicted block 912 to generate reconstructed image block 927. In some embodiments, reconstructed image block 927 can be referred by other names, such as a reconstructed sample block.

In some embodiments, the neural network 906 can be added between the inverse transform circuitry 907 and the inverse quantization circuitry 905 to generate recovered transform coefficients 923. In some embodiments, recovered transform coefficients 923 can also be referred to as recovered transform block 923, since the recovered transform coefficients included in the recovered transform block can form a two-dimensional matrix, which can be viewed as a block of data or coefficients. In some embodiments, the recovered transform coefficients 923 are a second dequantized transformed residual signal that is different from the dequantized transformed residual signal 921. Accordingly, the neural network 906 can receive a first dequantized transformed residual signal, e.g., the dequantized transformed residual signal 921, and generate the second dequantized transformed residual signal. In some embodiments, the recovered transform coefficients 923 can be an improvement of the dequantized transformed residual signal 921, while the recovered transform coefficients 923 performs the same function as the dequantized transformed residual signal 921. Accordingly, the reconstruction block 60 can still perform the same function without the neural network 906, where the inverse quantization circuitry 905 can be directly coupled to the inverse transform circuitry 907.

In some embodiments, the dequantized transformed residual signal 921 can be referred to as a first reconstructed transform coefficients, while the recovered transform coefficients 923 can be referred to as a second reconstructed transform coefficients. The inverse transform circuitry 907 can receive either the first reconstructed transform coefficients (the dequantized transformed residual signal 921) and generate a first reconstructed residue signal, or receive the second reconstructed transform coefficients (the recovered transform coefficients 923) and generate a second reconstructed residue signal, where the second reconstructed residue signal can have improved signal quality, e.g., better approximation and smaller errors to transformed residual signal 917 than the first reconstructed residue signal.

In some embodiments, the neural network 906 may be referred by other names, or other neural networks may be used in reconstruction block 60 to perform different functions. However, two circuits or neural networks are not the same unless the two circuits or neural networks receive the same inputs and produce the same output on the received inputs. Hence, two neural networks or circuitries are not the same if their inputs are not the same, or they take the same inputs, but produce different outputs. Accordingly, the neural network 906 is defined by the inputs received and output produced and can be different from other neural networks or neural network decoders.

In some embodiments, the neural network 906 can receive the dequantized transformed residual signal 921 to produce the recovered transform coefficients 923, which are still a dequantized transformed residual signal before any inverse transform operations have been performed. The inverse transform operations are performed by the inverse transform circuitry 907 before the addition circuitry 908 generating reconstructed image block 927 based on the predicted block 912. Accordingly, the neural network 906 receives a first dequantized transformed residual signal (the dequantized transformed residual signal 921) to produce a second dequantized transformed residual signal (the recovered transform coefficients 923) without using or being based on a prediction signal, e.g., the predicted block 912.

In some embodiments, the neural network 906 can be different from other neural networks, neural network decoders, or other decoders due to its position and connections. In some embodiments, the neural network 906 is directly coupled to the inverse quantization circuitry 905 and directly coupled to the inverse transform circuitry 907, where the inverse quantization circuitry 905 performs the inverse quantization operations, and the inverse transform circuitry 907 performs the inverse transform operations on the dequantized transformed residual signal. In some embodiments, the neural network 906 can receive outputs from the inverse quantization circuitry 905 as its inputs without going through other circuits. Similarly, the neural network 906 can provide outputs to the inverse transform circuitry 907 without going through other circuits. Accordingly, the neural network 906 is not directly coupled to the quantization circuitry 904 but coupled to quantization circuitry 904 through the inverse quantization circuitry 905.

In some embodiments, the neural network 906 can be viewed as a first dequanitzer directly coupled to a second dequanitzer (the inverse quantization circuitry 905) and directly coupled to an inverse transformer (inverse transform circuitry 907). In some embodiments, the neural network 906 performs additional inverse quantization operations or additional dequantization operations after inverse quantization operations are performed by the inverse quantization circuitry 905. In some embodiments, the inverse quantization circuitry 905 can be a circuit that is not a neural network. Instead, the inverse quantization circuitry 905 can perform inverse quantization or dequantization operations based on a process of mapping a quantized integer back to a continuous approximation of the original value based on a quantization step size or quantization matrix. In some embodiments, the inverse quantization circuitry 905 can implement the inverse quantization or dequantization operations using a table look-up operation to map each quantization index to a corresponding reconstruction value without using a neural network.

In some embodiments, the neural network 906 can receive dequantized transformed residual signal 921 and generate the recovered transform coefficients 923, which can be included in a recovered transform block. Accordingly, operations performed by the neural network 906 can be referred to as a transform coefficient recovery (TCR) process. In some embodiments, recovered transform coefficients 923 can be an approximation to transformed residual signal 917 before the quantization operations are performed on transformed residual signal 917. In some embodiments, recovered transform coefficients 923 generated by neural network 906 can provide better approximation and smaller errors to transformed residual signal 917 than the errors between dequantized transformed residual signal 921 and transformed residual signal 917. In some embodiments, a first error between the recovered transform block 923 and the transformed residual block 917 can be smaller than a second error between the transformed residual block 917 and the dequantized transformed residual block 921 generated by performing inverse quantization operations on the quantized transformed residual block 919, where the first error and the second error are determined based on a cost function.

In some embodiments, neural network 906 can receive dequantized transformed residual signal 921 as the input to perform additional operations besides the inverse transform operations performed by inverse transform circuitry 907. In some embodiments, neural network 906 can receive quantized transformed residual signal 919 directly from the quantization circuitry 904 and perform neural network operations to generate recovered transform coefficients 923 by machine learning mechanisms without generating dequantized transformed residual signal 921 by the inverse quantization circuitry 905.

In some embodiments, as shown in FIG. 9B, a binary classification network 961 can be coupled to neural network 906 to receive recovered transform block 923 and to generate a numerical confidence score 963 for recovered transform block 923. In addition, a selection circuitry 965 can be coupled to binary classification network 961 to receive confidence score 963 as a control signal, coupled to inverse quantization circuitry 905 to receive dequantized transformed residual block 921, and coupled to neural network 906 to receive recovered transform block 923, and further generate a selected dequantized transformed block 966. In some embodiments, selected dequantized transformed block 966 can be referred to as the selected dequantized transformed coefficients.

In some embodiments, binary classification network 961 can be a classification neural network, while neural network 906 can be a regression neural network. In some embodiments, neural network 906 can be further defined based on various parameters, e.g., the intra mode of the intra frame of frames of a video stream.

In some embodiments, the operations of selection circuitry 965 can be described as follows. In some embodiments, selection circuitry 965 can compare confidence score 963 with a predetermined threshold value 967. In response to a determination that confidence score 963 is higher than predetermined threshold value 967, selection circuitry 965 generates selected dequantized transformed block 966 to be recovered transform block 923. Accordingly, selected dequantized transformed block 966 can have the same value as recovered transform block 923. In some embodiments, in response to a determination that confidence score 963 is lower than or equal to predetermined threshold value 967, selection circuitry 965 can generate selected dequantized transformed block 966 to be dequantized transformed residual block 921. Accordingly, selected dequantized transformed block 966 can have the same value as dequantized transformed residual block 921.

In some embodiments, binary classification network 961 can include a first layer 962 of nodes and a second layer 964 of nodes. In some embodiments, the first layer 962 of nodes can receive an input vector 969, which is converted from recovered transform block 923 including the recovered transform coefficients organized in a two-dimensional matrix format. In some embodiments, recovered transform block 923 can include an 8*8 matrix of coefficients. Accordingly, the first layer 962 can receive the input vector of size 64, which represents the vector converted from the 8*8 matrix of coefficients of recovered transform block 923. The first layer 962 can include 64 nodes to receive the input vector of 64 coefficients. In some embodiments, the activation function of the node of the first layer 962 can include a ReLU or LeakyReLu function. Accordingly, the first layer 962 can further generate a first layer result vector 968 for input vector 969. In some embodiments, each node of the first layer 962 can generate the first layer result vector 968, which can be defined as an output included in the first layer result vector 968=ReLu (input*weight+bias), where input can be a value of the input vector 969, and weight and bias are stored in the first layer 962. In some embodiments, the second layer 964 can include a node to receive the first layer result vector 968 to generate confidence score 963. In some embodiments, the confidence score 963 can be generated by Sigmoid (the output included in the first layer result vector 968*weight 2+bias 2), where weight 2+bias 2 weight 2+bias 2 are stored in the second layer 964. In some embodiments, confidence score 963 can be a real number between 0 and 1, which can represent a probability.

In some embodiments, binary classification network 961 can be trained using a loss function including a binary cross-entropy (BCE) function to generate the confidence score. In some embodiments, the loss function used in training binary classification network 961 can be defined as MSE+L*BCE, where L can be an adjustable parameter. In some embodiments, BCE can be defined by the following equation, where N is the number of observations, yᵢ is the binary label (0 or 1) of the i^{th} observation, and pᵢ is the predicted probability of the i^{th} observation being in class 1:

$$BCE = - \frac{1}{N} {\sum }_{i = 1}^{N} [ {y}_{i} log ( {p}_{i} ) + ( 1 - {y}_{i} ) log ( 1 - {p}_{i} ) ] .$$

Furthermore, inverse transform circuitry 907 can perform inverse transform operations on selected dequantized transformed block 966. In some embodiments, selected dequantized transformed block 966 can either have the value of recovered transform coefficients 923 or dequantized transformed residual block 921, depending on confidence score 963 as described above. In some embodiments, operations can be described for selected dequantized transformed block 966 having the value of recovered transform coefficients 923. However, similar operations can be performed for selected dequantized transformed block 966 having the value of dequantized transformed residual block 921. In some embodiments, inverse transform circuitry 907 can perform inverse transform operations on recovered transform coefficients 923 or dequantized transformed residual block 921 to generate reconstructed residue signal 925, which can be a reconstructed residue block. In some embodiments, reconstructed residue signal 925 generated based on recovered transform coefficients 923 can have better performance, e.g., lower error, than those reconstructed residue signals generated based on dequantized transformed residual signal 921. In some embodiments, reconstructed residue signal 925 generated based on recovered transform coefficients 923 can reduce errors introduced by the quantization circuitry 904.

In some embodiments, addition circuitry 908 can add the reconstructed residue signal 925 to predicted block 912 to generate reconstructed image block 927. In some embodiments, reconstructed image block 927 can be provided to prediction circuitry 902 for processing the next image block, e.g., input block 932. In addition, reconstructed image block 927 can be provided to in-loop filtering circuitry 909. Afterwards, based on reconstructed image block 927, in-loop filtering circuitry 909 can generate a filtered reconstructed image 929. In some embodiments, the in-loop filtering circuitry 909 can perform a filtering operation on the frame level, e.g., on a reconstructed image including multiple reconstructed image blocks corresponding to the multiple input blocks of the image 911 and to generate the filtered reconstructed image 929. In some embodiments, filtered reconstructed image 929 can be further provided to prediction circuitry 902 for processing the next image block, e.g., input block 932. To improve the quality of reconstructed frames, in-loop filtering performed by in-loop filtering circuitry 909 can be applied and filtered reconstructed image 929 can be further employed as the reference frame of the following inter-predicted frames.

In some embodiments, reconstruction block 60 can implement video coding standards adopting hybrid video coding framework, including intra/inter prediction performed by prediction circuitry 902, transformation performed by transform circuitry 903, and quantization performed by quantization circuitry 904. In intra/inter prediction performed by prediction circuitry 902, each input frame can usually be split into non-overlapped blocks, such as input block 931 and input block 932, and the block-wise intra/inter prediction is performed to remove the spatial redundancies. To further reduce the spatial redundancy, residual signal 915 between input block 931 and predicted block 912 is transformed by transform circuitry 903. In some embodiments, transform circuitry 903 can perform discrete cosine transform (DCT) or discrete sine transform (DST). Through a quantization process performed by quantization circuitry 904, the unnecessary high frequency coefficients which are less perceivable to the human visual system can be removed. In some embodiments, the quantization process performed by quantization circuitry 904 can be controlled by quantization parameter (QP) 937, a quantization matrix 933, index values 935, or some other parameters. Accordingly, residual signal 915 can include the coefficients calculated based on input block 931, and can be transformed into the coefficients which is 917 based on the input block 931. Similarly, transformed residual signal 917, quantized transformed residual signal 919, dequantized transformed residual signal 921, recovered transform coefficients 923, reconstructed residue signal 925, and reconstructed image block 927 are all computed for one or more blocks of the image 911. In some embodiments, image 911 can be an original image of a frame of a video stream.

In some embodiments, neural network 906, which can receive dequantized transformed residual signal 921 and generate recovered transform coefficients 923, performs the operations using a CNN at a block level based on input block 931 of the image 911. Accordingly, neural network 906 performs operations different from recovering transformed pixel residuals performed in the context of still image coding, for example in JPEG artifact removal schemes. Such recovering transformed pixel residuals methods on an image can aim at maximizing image quality irrespective of cost, and use complex approaches, such as transformers or frame-level, cross-component processing, and multi-domain (transform+pixel) processing. Therefore, such frame level processing are generally not suitable for high throughput real-time requirements of a video codec, while neural network 906 performing the operations using a CNN at a block level based on input block 931 is more suitable for real time applications, such as video streaming.

In some embodiments, the TCR process performed by neural network 906 can be modeled as a dequantization problem instead of being an extra operation on top of a dequantization process performed by inverse quantization circuitry 905. The input of TCR in this case could be quantized coefficients included in quantized transformed residual signal 919 and quantization parameters (e.g., QP 937, or index values 935 or any parameters that specify a quantization step size), and the output could be dequantized coefficients included in recovered transform coefficients 923. The output of neural network 906 can then be fed normally into inverse transform circuitry 907 to derive the spatial domain residuals, e.g., reconstructed residual signal 925. In this way, the dequantization process performed by inverse quantization circuitry 905 can be replaced with the TCR process when the TCR process is enabled for the block. Such embodiments can keep the throughput and latency of the transform-quantization loop intact since a parallel data path is introduced in comparison to the dequantization by inverse quantization circuitry 905 and chaining the dequantization and the TCR process sequentially as shown in FIGS. 9A-9B.

In some embodiments, the TCR process performed by neural network 906 can also be trained to perform both the coefficient recovery as well as the inverse transform performed by inverse transform circuitry 907 in a single operation. The input of neural network 906 in this case could be quantized coefficients included in quantized transformed residual signal 919 and quantization parameters (e.g., QP 937, or index values 935 or any parameters that specify a quantization step size), and the output could be the spatial domain residuals, reconstructed residual signal 925. Accordingly, neural network 906 can perform the functions of inverse quantization circuitry 905 as well as inverse transform circuitry 907.

In some embodiments, there can be an end-to-end neural video compression using a neural network with improved performance over hybrid video coding approaches such as high efficiency video coding (HEVC) and versatile video coding (VVC). In some embodiments, an end-to-end neural video compression can include many components such as transform circuitry 903, quantization circuitry 904, inverse quantization circuitry 905, inverse transform circuitry 907, and/or optionally subtraction circuitry 901 and addition circuitry 908. However, end-to-end neural video compression using a neural network can have high cost prohibiting their use in real-life applications. Other improvements can include the application of local neural network, such as a CNN, designed and trained with hardware constraints in mind. Such local neural network can require a sophisticated use of model compression, heterogeneous quantization techniques and hardware aware neural architecture search. In some embodiments, neural networks can replace or augment manually designed in-loop restoration filters, such as in-loop filtering circuitry 909 operated at a frame level. Certain performance gain can be obtained when such a filter is applied on top of conventional encoders. However, even a relatively small CNN used in a component of existing neural video compression, such as in-loop filtering circuitry 909, may still require a million parameters (for example). As a consequence, thousands of multiply-accumulate (MACs) operations may be performed per pixel, which is in a serious disadvantage compared to a hand-engineered loop filter requiring dozens of per-pixel operations. Hence, embodiments focused on in-loop restoration filters using a neural network, such as in-loop filtering circuitry 909, can still have limited performance gain.

In some embodiments, unlike performing operations on frames by image decoders or in-loop filtering circuitry 909, neural network 906 can be applied by mode decision block 58 inside the encoder. Hence, neural network 906 can be selected at block-by-block basis in a rate-distortion optimal manner. Instead of attempting to restore image quality in the pixel domain of a frame in an expensive manner, neural network 906 of embodiments herein can apply a recovery operation in the transform domain at block-by-block basis. Using neural network 906, a machine learning (ML) model can be trained using various parameters including non-quantized signal, e.g., transformed residual signal 917 containing non-quantized transformed residual signal, dequantized transform residual signal contained in dequantized transformed residual signal 921, quantization matrix 933 or index value information 935 used in quantization circuitry 904, and other parameters. As trained, the ML model trained by neural network 906 can recover the AC coefficients lost (zeroed out) in the quantization process performed by quantization circuitry 904 and refine the precision of the quantized AC coefficient levels.

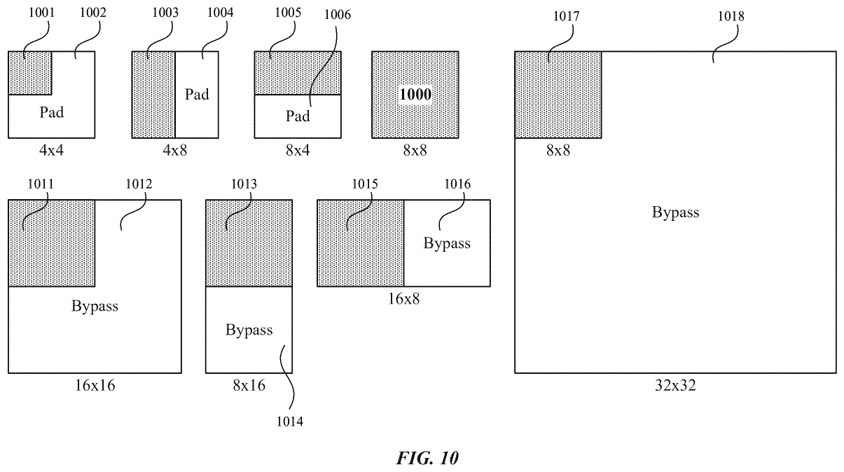

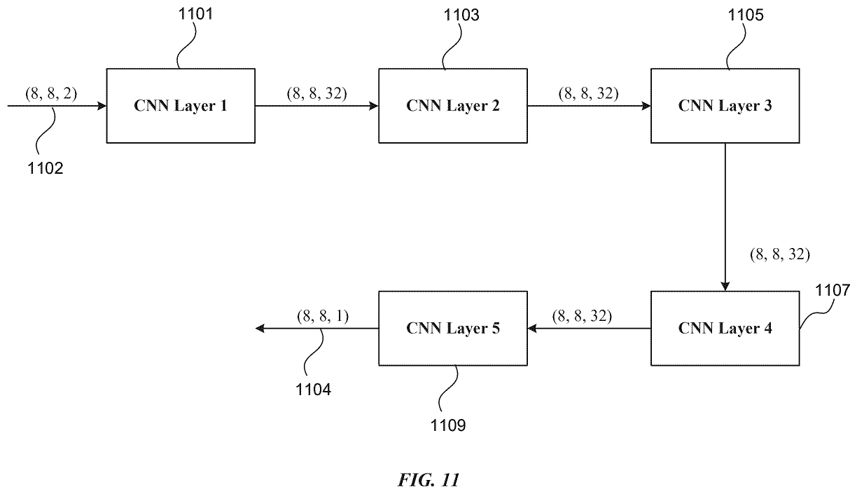

In some embodiments, the image 911 can be processed block by block, such as input block 931, input block 932, and total N blocks, where Nis an integer. Each input block, e.g., input block 931 or input block 932, can be the same size with the width W and height H. In some embodiments, input blocks of the image 911 can be different sizes, and a block modifier 910 can be used to convert an input block of a first size into an input block of a second size. In some embodiments, a first input block can have a first width of size W₁ and a height of size H₁, and a second input block can have a second width of size W₂ and a height of size H₂, where W₁ is different from W₂, or H₁ is different from H₂. Block modifier 910 can generate a revised second input block having the same size as the first input block by bypassing one or more coefficients of the second input block or padding additional zeros to the second input block. More examples of operations performed by block modifier 910 are shown in FIG. 10.

In some embodiments, neural network 906 can use a cost function 951 to generate recovered transform coefficients 923 over all N processed blocks with the width W and height H, cumulatively of image 911. In some embodiments, cost function 951 can have a first error defined by the sum of transform domain squared error (SSE) function between the input (non-quantized) signal, e.g., transformed residual signal 917, and the ML processed block SSE_{ML}, e.g., recovered transform coefficients 923 as shown equation (1). In addition, cost function 951 can have a second error defined by the SSE between the input (non-quantized) e.g., transformed residual signal 917, and non-ML (original) quantized-dequantized block SSE_{OG}, e.g., dequantized transformed residual signal 921, defined in equation (2). In some embodiments, the first error defined by equation (1) can be smaller than the second error defined by equation (2). Hence, the SSE_{gain}, defined in equation (3) can be less than 0 over N processed blocks cumulatively.

$${SSE}_{ML} = {\sum }_{n = 1}^{N} {\sum }_{i = 1 , j = 1}^{W , H} {( {coeff}_{i , j , n} - {mldqcoeff}_{i , j , n} )}^{2} \qquad ( 1 )$$

$${SSE}_{OG} = {\sum }_{n = 1}^{N} {\sum }_{i = 1 , j = 1}^{W , H} {( {coeff}_{i , j , n} - {dqcoeff}_{i , j , n} )}^{2} \qquad ( 2 )$$

$${SSE}_{gain} = {SSE}_{ML} - {SSE}_{OG} \qquad ( 3 )$$

In some embodiments, coeff_{i,j,n} can be a coefficient of transformed residual signal 917, which can include a matrix having width W and height H for block n that can be block 1, . . . N. Similarly, mldqcoeff_{i,j,n} can be a coefficient of recovered transform coefficients 923, which can include a matrix having width W and height H for block n that can be block 1, . . . N. In addition, dqcoeff_{i,j,n} can be a coefficient of dequantized transformed residual signal 921, which can include a matrix having width W and height H for block n that can be block 1, . . . , N. In some embodiments, cost function 951 can be constructed to minimize the global SSE_{gain} over all the training samples.

In some embodiments, other cost functions may also be used and combined with the above, such as a mean squared error (MSE) function, a sum of absolute deviations (SAD) cost function, a structural similarity index (SSIM) cost function, or a sum of absolute errors (SAE) function. In some embodiments, different weights can be used on different frequency components. The cost function calculation may also be implemented in the pixel domain, e.g., after inverse transform performed by inverse transform circuitry 907. In this case, more weight may be applied to the SSE on the bottom pixel row and the rightmost pixel column to emphasize the importance of the edge pixels as they may be used as predictors for future intra predicted blocks.

Examples of alternative loss-function approaches for training may be either to minimize the global SSE_{gain} as described above, or to only avoid the cases where a single per-transform unit SSE_{gain} gets positive (e.g., maximize the win rate). The former allows the model to sometimes make gross mistakes (while on average still producing best performance), while the latter will focus on never making the error worse at the cost of a more modest average improvement.

Embodiments herein can improve the residual signal in the transform domain, e.g., transformed residual signal 917, as opposed to improving the reconstructed image in the pixel domain, e.g., filtered reconstructed image 929. The transform domain recovered residuals, e.g., reconstructed image block 927, can form improved reconstructed blocks that can be used as predictors to prediction circuitry 902 for subsequent intra-coded blocks, thus the potential quality improvements will propagate within the multiple input blocks of the same frame, e.g., the image 911. On the other hand, loop filter based improvements, e.g., performed by in-loop filtering circuitry 909, can only impact the future frames that are larger in size than blocks.

In some embodiments, it can be configurable when to apply the TCR process using neural network 906. The application of the TCR process using neural network 906 can depend on the residual and prediction characteristics of the current input block 931 as well as its local neighborhood. In some embodiments, the TCR process may not be applied when transform circuitry 903 does not perform any transform. Similarly, the TCR process may not be applied for blocks that do not have enough non-zero AC coefficients to make a good prediction from.

Embodiments herein can make the ML model using neural network 906 smaller by only focusing on particular residual coefficient range, such as the top-left quadrant, or the top-left 1/16th part of input block 931. This will alone make the model's computational complexity many times smaller than a model that processes all pixels in pixel domain of a frame. In an encoder implementation, the TCR process can be used as an encoder rate-distortion optimized quantization (RDOQ) tool such that it can be used for rate reduction purposes. In particular, the encoder can choose to zero out certain coefficients when it knows that the TCR process can recover them, thus reducing the cost of signaling the residual block. For example, an encoder could utilize a hard limit of N(quant_step) non-zero coefficients, after which everything else is zeroed out. In another example, an encoder's RDOQ process can be a machine learning based approach that is jointly trained with the TCR process such that the quantized coefficients after RDOQ are selected such that TCR's performance is maximized. Encoder may also be able to use higher quantization steps than before to achieve the same quality as before, when the TCR process is enabled.

In some embodiments, neural network 906 can have a CNN architecture including multiple layers such as an input layer 941, an output layer 945, and one or more hidden layer 943. In some embodiments, input layer 941, output layer 945, and hidden layer 943 can be a convolutional layer or a ReLU layer. A convolutional layer can compute the output of neurons that are connected to local regions in the input block, each computing a dot product between their weights and a small region they are connected to. A ReLU layer can apply an elementwise activation function, such as the max(0, x) with a zero threshold. The parameters in the convolutional layers can be trained with gradient descent under a proper cost function, such as cost function 951. Employing convolutional layer and ReLU layer, the CNN for neural network 906 can be taken as an alternating sequence of linear filtering and nonlinear transformation operations.

In some embodiments, besides regular CNN layers, neural network 906 can include a CNN containing other type of layers such as fully connected layers, separable convolution layers, depth and point wise convolutional layers, residual/skip connections and maxpools, non-linearities such as Sigmoids, ReLU or leaky ReLU layers, or some other layers. In some embodiments, neural network 906 can include a set of fully connected layers with ReLUs for activation and if needed, with linear regressors. The inputs to neural network 906 can include previously decoded transform coefficients, block size, N of coefficients to modulate, prediction type (inter or intra), mode if intra prediction type, transform type, and some other parameters. In some embodiments, in the case where weighted prediction is enabled, the output of the TCR process performed by neural network 906 may be a weighted sum of the TCR disable and the TCR enable path.

In some embodiments, the inputs may traverse through neural network 906 model layers (for example, convolutional and fully connected layers), and the final layer, which is output layer 945, may output a recovered transform block (e.g., 8×8, or a portion thereof, such as the top-level 4×4) as recovered transform coefficients 923. In case only a portion of the transform block size is processed by neural network 906, the outside region (e.g., everything except the top-left quadrant) can either be zeroed out, or is not modified. The DC coefficient may be not modified by the process. The resulting recovered transform coefficients 923 may be inverse transformed normally by inverse transform circuitry 907.

In some embodiments, the output of the final layer, e.g., output layer 945, may have clipping operations on each nonzero coefficient of the processed transform block, such that the absolute difference between the input coefficient and processed coefficient is within a given range and processed coefficient can be trimmed to avoid outliers. Further guardrails may be implemented as part of the clipping process, such as avoiding the decimation (setting to zero) or sign inversion (changing a positive coefficient to negative or vice versa) of a coefficient. The clipping logic may compare each ML model output coefficient value to the original value and either clip or entirely discard the ML modification of that coefficient in the event of encountering decimation or sign inversion.

In some embodiments, the ML model functionality performed by neural network 906 can be converted into a look-up table search where the commonly occurring patterns (location, level) of non-zero AC coefficients form an index(es) to said table(s), and the tables define the refinements (recovering zeroed out coefficients, modifying the levels of existing dequantized coefficients) applied to the output matrix. If the indices formed by the patterns are not found in the LUT, the TCR processing can be skipped for that block.

In some embodiments, neural network 906 can receive dequantized transformed residual signal 921, which can include inverse quantized transform block (e.g., 8×8), or a portion thereof (e.g., the top-left 4×4) and quantization matrix 933 or another scheme signaling the per-coefficient quantizers as its inputs. Additional parameters can be provided to neural network 906 as well.

In some embodiments, features derived from transformed residual signal 917, which can be a transform block, can be provided to neural network 906. In some embodiments, such features can include directional gradients of the transform performed by transform circuitry 903, a transform type (for example but not limited to DCT, DST), a transform size (for example but not limited to 8×8), a prediction mode (for example but not limited to intra_vertical, palette, intra_block_copy, compound inter), a prediction pixel block, a neighboring reconstruction samples, a neighboring transform coefficients, a number of nonzero (quantized or dequantized) transform coefficients, a chroma/non-luma sampling rate (e.g., 4:2:0, 4:2:2, or 4:4:4), and a plane type (e.g., luma pixel, chroma pixel, depth, alpha etc.).

In some embodiments, neural network 906 can either directly ingest blocks of different sizes, or a specific scaler function can be applied first to normalize the input block size (e.g., from 32×16 to 8×8) into a single size supported by neural network 906, such as 910 block modifier. Inverse scaling can be similarly applied at the output of neural network 906, or neural network 906 can output the final size directly.

FIG. 10 shows several examples of various transform block sizes, and how neural network 906 can process an 8×8 block size as shown in block 1000. This approach allows having a single model architecture (as opposed to a dedicated architecture for each transform block size), which may reduce the implementation cost. In some embodiments, 8×8 is an example size for such a fixed size architecture; 4×4 or 16×16 could also be chosen among other sizes to be the native ingest size for neural network 906.

In some embodiments, block 1001 can have a size of 4×4, and it can be padded to size 8×8 by adding 0s as coefficients forming a block 1002 around or below the 1001 block. Similarly, block 1003 can have a size of 4×8, and it can be padded to size 8×8 by adding 0 coefficients forming a block 1004 to the right side of block 1003. In addition, block 1005 can have a size of 8×4, and it can be padded to size 8×8 by adding 0 coefficients forming a block 1006 to the bottom side of block 1005.

In some embodiments, block 1012 can have a size of 16×16, a smaller block 1011 of 8×8 size can be selected for the TCR process by neural network 906. Similarly, block 1014 can have a size of 8×16, a smaller block 1013 of 8×8 size as the top half of block 1014 can be selected for the TCR process by neural network 906. In addition, block 1016 can have a size of 16×8, a smaller block 1015 of 8×8 size as the left half of block 1016 can be selected for the TCR process by neural network 906. Furthermore, block 1018 can have a size of 32×32, a smaller block 1017 of 8×8 size as the top corner of block 1018 can be selected for the TCR process by neural network 906.

In some embodiments, neural network 906 can only process the first 8×8 coefficient region in raster-scan order of any sized transform whose width and height is ≥8. Input coefficients that are outside of the top-left 8×8 may not be modified by the process. For transform sizes smaller than 8×8, the missing values may be padded with zero coefficients to extend the size to 8×8. Padding may also be done one-dimensionally, for example a 4×16 block could be padded to 8×16 before applying the TCR processing on the first 8×8 area created this way. The coefficients modified this way in the padded areas may be discarded after the TCR process.

FIG. 11 shows an example architecture for neural network 906 that may be used to implement the TCR process. Inputs 1102 to neural network 906 may be two 8×8 matrices, one holding the dequantized coefficients of dequantized transformed residual signal 921, and the other holding the quantization step values, e.g., quantization matrix 933. Neural network 906 can include a CNN with 5 layers, e.g., a layer 1101, a layer 1103, a layer 1105, a layer 1107, and a layer 1109 producing an output 1104. Each layer can use 3×3 kernels and each (inner) layer can have 32 input and 32 output channels. In the final layer, layer 1109, only one output channel may be produced which contains the TCR processed 8×8 coefficient matrix.

For this model, layer specific MACs per pixel are calculated by K*K*Cin*Cout, where K is the convolutional kernel size, Cin is input channels and Cout is output channels. Accordingly, neural network 906 shown in FIG. 11 can perform operations counted as 3*3*2*32 (layer 1)+3*3*32*32*3 (layer 2-4)+3*3*32 (layer 5)=28,512 MACs/pixel.

In some encoder implementation embodiments, the TCR process can be applied on each transform unit, which can be an example of input block 931, and calculate a SSE between the input coefficients (before quantization, transformed residual block (917) and output coefficients (after quantization and dequantization, dequantized transformed residual block 921), for both TCR off and TCR on case. The encoder may also use other error metrics such as MSE, SAD or SSIM, and it may set different weights on different frequency components (e.g., higher weight for lower frequencies deemed more important). This forms the distortion part of the RDO equation. In addition the rate cost of the TCR enable/disable flag can be applied, which may use contexts to optimize the probability of value 0 or 1. The contexts may be derived from the model and block level conditions described previously. By implementing the TCR process in a rate-distortion optimal mode decision loop, using the TCR process can never degrade the image from the RD-perspective.

In some embodiments, the SSE calculation may also be implemented in pixel domain, e.g., after inverse transform performed by inverse transform circuitry 907. In this case, the encoder may apply more weight to the SSE on the bottom pixel row and the rightmost pixel column to emphasize the importance of the edge pixels as they are used as predictors for future intra predicted blocks.

In some embodiments, an encoder may apply the TCR process on all of the RDO candidates (e.g., ones using different transform sizes and types, different prediction modes etc.), or just the N best ones, where N≥1. The more candidates exposed to the TCR process, the higher coding gain can be achieved.

In some embodiments of encoder implementations, the TCR process can be used as an encoder RDOQ tool such that it can be used for rate reduction purposes. In particular, the encoder can choose to zero out certain coefficients when it knows that the TCR process can recover them, thus reducing the cost of signaling the residual block. For example, an encoder could utilize a hard limit of N(quant_step) non-zero coefficients, after which everything else is zeroed out. In some embodiments, the encoder may also be able to use higher quantization steps than before to achieve the same quality as before, when TCR is enabled.

In some embodiments, the TCR process can be applied to a decoder 1207 of a receiver device 1203, as shown in FIG. 12. In some embodiments, a sender device 1201 can communicate with receiver device 1203, where a bit stream, e.g., video stream 1211, is transmitted from sender device 1201 through a network interface 24a to receiver device 1203 through a network interface 24b. Accordingly, receiver device 1203 is configured to receive a bit stream, e.g., video stream 1211, from an encoder 1205 of sender device 1201.

In some embodiments, sender device 1201 can include a codec 1202 having the encoder 1205, while receiver device 1203 can include a codec 1204 having decoder 1207. In some embodiments, sender device 1201 and receiver device 1203 can be examples of electronic device 10, while codec 1202 and codec 1204 can be examples of codec 31. Encoder 1205 can generate video stream 1211 including a sequence of frames or images, which can be similar to the image 911 shown in FIGS. 9A-9B.

In some embodiments, video stream 1211 can include a quantized transformed residual block 919 of an input block of an image, where the quantized transformed residual block 919 can be generated by performing quantization operations by quantization circuitry 904 of encoder 1205 on transformed residual block 917 for a residual block determined as a difference between the input block and a predicted block of the input block, as described for the operations of FIGS. 9A-9B.

In some embodiments, receiver device 1203 can include network interface 24b, a controller 1213, and codec 1204 including reconstruction block 60, which is a reconstruction circuitry. In some embodiments, controller 1213 can be coupled to network interface 24b and configured to determine one or more decoding parameters for decoding the bit stream, e.g., video stream 1211. Reconstruction circuitry, e.g., reconstruction block 60, can include a neural network 906 configured to generate recovered transform block 923, where recovered transform block 923 can include recovered transform coefficients for the quantized transformed residual block 919 to reduce errors introduced by quantization circuitry 904. In some embodiments, a first error between the recovered transform block 923 and the transformed residual block 917 can be smaller than a second error between the transformed residual block 917 and a dequantized transformed residual block generated by performing inverse quantization operations on the quantized transformed residual block 919, where the first error and the second error are determined based on a cost function.

In some embodiments, the bit stream, e.g., video stream 1211, includes a video bit stream having a sequence of frames, where a frame 1221 can include multiple quantized transformed residual blocks 919 corresponding to multiple input blocks of frame 1221, and one or more decoding parameters for decoding the bit stream. In some embodiments, the one or more decoding parameters can include one or more sequence level indicators 1223, one or more frame level indicators 1225 for the image that is a frame of the video bit stream, one or more superblock level indicators 1227 for blocks of the frame, and one or more block level indicators 1229 for the input block of the image. In some embodiments, the one or more decoding parameters further includes an error range indicator to indicate a maximum range of quantization error in the frame caused by rounding, truncation, trellis, Rate-Distortion Optimized Quantization (RDOQ), or dead zone quantization errors. More examples of various decoding parameters are illustrated below.

In some embodiments, controller 1213 can be further configured to determine a set of machine learning parameters for neural network 906 to generate the recovered transform block 923. In some embodiments, the set of machine learning parameters can include a parameter indicating a frame type for the frame, a parameter indicating a quantization parameter range, and a number of non-zero coefficients range for the quantized transformed residual block. In some embodiments, the one or more block level indicators indicate a block quantization parameter, a transform unit parameter for a transform circuitry performing a transform to generate the transformed residual block for a residual block, a prediction mode used by a prediction circuitry to generate the predicted block of the input block. In some embodiments, the set of machine learning parameters can be defined as a set of default machine learning parameters that are explicitly described in the codec specification text. In some embodiments, there can be multiple sets of parameters, for example, for different QP bands (e.g. 5), and intra/inter/screen content coding (total 5*3=15 sets). Furthermore, it may also be possible that unique parameter set (outside of the 15 default ones) is signaled at the start of the video bitstream, in which case it is optimized per sequence. In some embodiments, neural network 906 can support different bitdepth images (e.g. 8, 10, 12 bits per pixel). In some embodiments, neural network 906 can select only one bitdepth for processing, which may be selected as the highest or the lowest bitdepths of the multiple bitdepths. Embodiments can shift the dequantized transform coefficients prior to the process by neural network 906, and shift back to the original bitdepth after being processed by neural network 906.

To enable decoding, encoding parameters used to generate encoded image data in video stream 1211 may be communicated to a decoding device, e.g., decoder 1207. In some embodiments, the encoding parameters may include the encoding parameters determined by the mode decision block 58 (e.g., prediction unit configuration and/or transform unit configuration), encoding parameters used by the reconstruction block 60 (e.g., quantization coefficients), and encoding parameters used by the filter block 62. To facilitate communication, the encoding parameters may be expressed as syntax elements. For example, a first syntax element may indicate a prediction mode (e.g., inter prediction mode or intra prediction mode), a second syntax element may indicate a quantization coefficient, a third syntax element may indicate configuration of prediction units, and a fourth syntax element may indicate configuration of transform units.

In some embodiments, sequence level signaling of one or more sequence level indicators 1223 can be performed. The sequence level header may implement a new flag called transform_coeff_recovery_enable. This allows an encoder that does not implement the TCR process not to signal its use at the frame and block level and waste bits in the signaling.

Following the enable flag, the sequence level header may further implement a tcr_ml_parameter_set_present flag, which when 1, may be followed by N bytes of sequence specific ML model parameters (weights and biases), which may be used to override the normative parameters used by default. This allows the TCR process to be optimized on a per-sequence basis.

In some embodiments, frame level signaling of one or more frame level indicators 1225 can be performed. The frame level header may implement a multi-bit symbol called tcrpresent, which can be defined, for example, as follows:
tr_present equals 0: TCR is disabled for this frame.
tr_present equals 1: Block level TCR usage is signaled and determined explicitly when the block level conditions (defined below) are fully or partially met.
tr_present equals 2: Block level TCR is enabled for all those blocks that meet below conditions fully or partially (no explicit block level signaling will be present in the bitstream), and otherwise disabled.
tr_present equals 3: A superblock level flag will indicate whether TCR usage is signaled and determined explicitly, or decided based on whether the below conditions are met.
tr_present equals 4: A coding unit level flag will indicate whether TCR usage is signaled and determined explicitly, or decided based on whether the below conditions are met.

When tr_present is >0, the frame level header may include a next signal tcr_param_index, which is a multi-bit field that can provide an index to up to N sets of ML model params (weights and biases). The signaled model parameter set may be used for all blocks of this frame.

When tr_present is >0, a tr_plane_info field may be further signaled to indicate to which planes (Y, Cb, Cr, alpha, depth etc.) the TCR process is applied.

When tr_present is >0, a multi-bit field tcr_quant_error_range_minus1 may be signaled to inform the decoder the maximum range of quantization error in the frame caused by rounding, truncation, trellis, RDOQ, deadzone quantization or similar tool employed in the encoder. For example, value 0 would mean that the maximum quantization error is one Q-step, and value 3 would indicate a maximum quantization error is four Q-steps. This value may be used to constrain the maximum absolute ML model output value difference (output coefficient−input coefficient) for every refined/recovered coefficient.

Further, when tr_present >0, a multi-bit field sign_inversion_mode may be signaled. When tr_present is 0, it may indicate that the value of a negative dequantized coefficient cannot be modified to be larger than −1 by TCR, and similarly the value of a positive dequantized coefficient cannot be modified to be smaller than 1 by TCR. This rule means that negative coefficients should stay negative and non-zero and positive coefficients should stay positive and non-zero. When sign_inversion_mode is 1, TCR's modification range is only constrained by the tcr_quant_error_range_minus1. Dequantized coefficients with value 0 may be modified in either direction regardless of the flag value. In some embodiments, a value 2 can be used for sign_inversion_mode to inform the decoding process to discard (instead of clipping) the output coefficients that break the above sign inversion mode rule; in this case the dequantized coefficient is unmodified by the TCR process.

In some embodiments, the ML model trained by a neural network such as neural network 906 may have multiple parameter sets (weights and biases) from which the decoder 1207 can load one set per frame when tr_present >0. The weight set can, for example, be decided based on the frame's base QP value and frame type. The chosen parameter set can be used for the entire frame. Switching tiles within a frame may require reloading the parameter set, if the frame type or base QP range differs from a previous tile, or if the frame is split into multiple tiles and each tile is processed by a separate software instance or hardware core. The ML parameter set also defines the valid range of non-zero coefficients where the TCR process can be turned on.

Actual QP band thresholds may be signaled in the sequence header. Additional parameter sets may be defined for the case when a non-flat quantization method is being used.

A video codec specification implementing the TCR process may have normative ML model parameter sets that are known by decoders, and additionally each video sequence may have its own optimized ML model parameter sets that are signaled before the actual video data and that override the normative default sets.

In some embodiments, various block level signaling can be performed for one or more superblock level indicators 1227 or one or more block level indicators 1229. When the frame level TCR is >0, the decoder may determine some model and block level conditions, or parts thereof (e.g., not limited to these conditions).

When all or some of the conditions are met, and the tr_present flag is 1, decoder may decode a use_tcr bit from the bitstream for each such block. When the use_tcr bit decoded this way is 1, the TCR process is applied, and when 0, it is skipped.

If tr_present flag is 2 and the conditions are fully or partially met, the TCR process may be directly applied without decoding use_tcr bit, which saves the signaling cost of TCR.

If tr_present flag is ≥3, an additional superblock/coding unit level TCR flag may be decoded first and that may determine if use_tcr bit is present or not for the TUs within that superblock/coding unit, when the above conditions for each TU are fully or partially met.

Alternatively, instead of applying conditional signaling of block-level syntax that indicate the use of the TCR process, the block-level syntax is still signaled regardless of whether the condition(s) is met, however, the condition(s) can be used to derive the context for signaling (e.g., entropy coding or parsing) the syntax.

In some embodiments of the TCR process, a weighted prediction mode may be signaled, and the final output is a per-coefficient weighted average of TCR input and TCR output. For example, if at the coefficient location (4, 5), the input value is 0, and it is 20 after the TCR process, the final value would be set to 10 given equal weight.

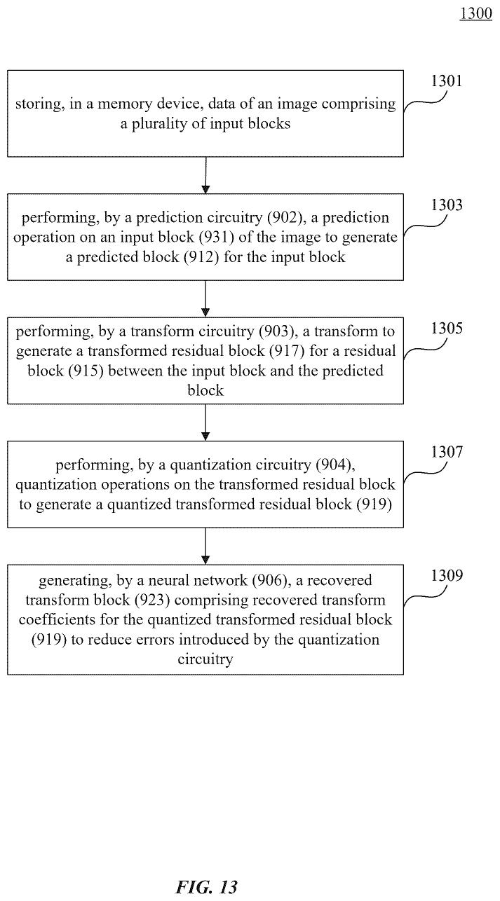

FIG. 13 illustrates a process 1300 performed by a reconstruction block having a neural network in a codec, in accordance with an embodiment. For illustrative purposes, the operations illustrated in process 1300 will be described with reference to neural network 906 in reconstruction block 60 of codec 31. Other representations of systems for performing operations of process 1300 are possible. Also, additional operations may be performed between various operations of process 1300 and may be omitted merely for clarity and ease of description. The additional operations can be provided before, during, and/or after process 1300. Moreover, not all operations may be needed to perform the disclosure provided herein. Additionally, some of the operations may be performed simultaneously or in a different order than shown in FIG. 13. In some embodiments, one or more other operations may be performed in addition to or in place of the presently-described operations.

At operation 1301, data of an image, such as image 911, which can include multiple input blocks, such as input block 931 and input block 932, can be stored in a memory device, such as memory device 38 of FIG. 6, memory device 36 of FIG. 7, or memory device 89 of FIG. 8.

At operation 1303, prediction circuitry 902 can perform a prediction operation on an input block 931 of the image 911 to generate predicted block 912 for the input block 931. As shown in FIGS. 9A-9B, prediction circuitry 902 can further provide the predicted block 912 to the subtraction circuitry 901. Afterwards, the subtraction circuitry 901 can subtract the predicted block 912 from the input block 931 to generate a residual signal 915.

At operation 1305, transform circuitry 903 can perform a transform to generate transformed residual block 917 for residual block 915 between the input block 931 and the predicted block 912. Accordingly, transformed residual signal 917 can include non-quantized transformed residual signal.

At operation 1307, quantization circuitry 904 can perform quantization operations on the transformed residual block 917 to generate quantized transformed residual block 919, which can be a quantized transformed residual block.

At operation 1309, neural network 906 can generate a recovered transform block 923 including recovered transform coefficients 923 for the quantized transformed residual block 919 to reduce errors introduced by quantization circuitry 904. In some embodiments, a first error between recovered transform block 923 and transformed residual block 917 can be smaller than a second error between transformed residual block 917 and dequantized transformed residual block 921 generated by performing inverse quantization operations on quantized transformed residual block 919, where the first error and the second error are determined based on a cost function, such as cost function 951.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure can discuss potential advantages that can arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages can depend on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (e.g., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (e.g., having the potential to, being able to) and not in a mandatory sense (e.g., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers (1) x but not y, (2) y but not x, and (3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” and “given circuit”) refer to different instances of the feature. Additionally, the labels “first,” “second,” and “third” when applied to a feature do not imply any type of ordering (e.g., spatial, temporal, and logical), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

In this disclosure, different entities (which may variously be referred to as “units,” “circuits,” and “other components”) may be described or claimed as “configured” to perform one or more tasks or operations. This formulation—[entity] configured to [perform one or more tasks]—is used herein to refer to structure (e.g., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, and latches), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, and memory management unit (MMU)). Such units also refer to circuits or circuitry.

The disclosed circuits/units/components and other elements illustrated in the drawings and described herein thus include hardware elements such as those described in the preceding paragraph. In many instances, the internal arrangement of hardware elements in a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description can be expressed in a fashion that may appear to be functional. But to those of skill in the art in this field, this HDL description is the manner that is used to transform the structure of a circuit, unit, or component to the next level of implementational detail. Such an HDL description may take the form of behavioral code (which may not be synthesizable), register transfer language (RTL) code (which, in contrast to behavioral code, may be synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, and inductors) and interconnect between the transistors and circuit elements. Some embodiments may implement multiple integrated circuits coupled to one another to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

What is claimed is:

1. A device, comprising:
a network interface to receive a bit stream from an encoder, wherein the bit stream comprises a quantized transformed residual block of an input block of a plurality of input blocks of an image, wherein the quantized transformed residual block is generated by performing quantization operations by a quantization circuitry of the encoder on a transformed residual block for a residual block determined as a difference between the input block and a predicted block of the input block;
a controller coupled to the network interface and to determine one or more decoding parameters for decoding the bit stream; and
reconstruction circuitry comprising a neural network to generate a recovered transform block comprising recovered transform coefficients for the quantized transformed residual block to reduce errors introduced by the quantization circuitry, wherein a first error between the recovered transform block and the transformed residual block is smaller than a second error between the transformed residual block and a dequantized transformed residual block generated by performing inverse quantization operations on the quantized transformed residual block, and wherein the first error and the second error are to be determined based on a cost function.

2. The device of claim 1, wherein the bit stream is to comprise a video bit stream having a sequence of frames, the one or more decoding parameters for decoding the bit stream are to comprise one or more sequence level indicators, one or more frame level indicators for the image that is a frame of the video bit stream, one or more superblock level indicators for a plurality of blocks of the frame, and one or more block level indicators for the input block of the image.

3. The device of claim 2, wherein the one or more decoding parameters are to further comprise an error range indicator to indicate a maximum range of quantization error in the frame caused by rounding, truncation, trellis, Rate-Distortion Optimized Quantization (RDOQ), or dead zone quantization errors.

4. The device of claim 2, wherein the controller is to further determine a set of machine learning parameters for the neural network to generate the recovered transform block, wherein the set of machine learning parameters is to comprise a parameter indicating a frame type for the frame, a parameter indicating a quantization parameter range, and a number of non-zero coefficients range for the quantized transformed residual block.

5. The device of claim 2, wherein the one or more block level indicators are to comprise a block quantization parameter, a transform unit parameter for a transform circuitry performing a transform to generate the transformed residual block for a residual block, a prediction mode used by a prediction circuitry to generate the predicted block of the input block.

6. The device of claim 1, wherein the neural network is to comprise an input layer, an output layer, and one or more hidden layers, wherein the neural network is to receive one or more parameters associated with a transform performed to generate the transformed residual block for the residual block, or with a prediction operation performed to generate the predicted block of the input block, and wherein the one or more parameters are selected from a transform type comprising a discrete cosine transform (DCT) or a discrete sine transform (DST), a transform block size, a prediction mode, a prediction pixel block, a neighboring reconstruction sample, and a plane type of the image.

7. The device of claim 1, wherein a first input block of the plurality of input blocks of the image has a first width of size W₁ and a height of size H₁, and a second input block of the plurality of input blocks of the image has a second width of size W₂ and a height of size H₂, and wherein the device further comprises a block modifier to generate a revised second input block having a same size as the first input block by bypassing one or more coefficients of the second input block or padding additional zeros to the second input block.

8. A device, comprising:
a memory device to store data of an image comprising a plurality of input blocks;
prediction circuitry to receive an input block of the image and perform a prediction operation on the input block to generate a predicted block for the input block;
transform circuitry to perform a transform on a residual block to generate a transformed residual block for the residual block between the input block and the predicted block;
quantization circuitry to perform quantization operations on the transformed residual block to generate a quantized transformed residual block; and
a neural network to generate a recovered transform block comprising recovered transform coefficients for the quantized transformed residual block to reduce errors introduced by the quantization circuitry, where a first error between the recovered transform block and the transformed residual block is smaller than a second error between the transformed residual block and a dequantized transformed residual block generated by performing inverse quantization operations on the quantized transformed residual block, and where the first error and the second error are to be determined based on a cost function.

9. The device of claim 8, wherein the neural network is directly coupled to the quantization circuitry and is to further receive the quantized transformed residual block and to generate the recovered transform block.

10. The device of claim 8, wherein the transform performed by the transform circuitry comprises a discrete cosine transform (DCT) or a discrete sine transform (DST), and wherein the transform circuitry is to generate the transformed residual block by the DCT or the DST for the residual block.

11. The device of claim 8, wherein the transform circuitry is to perform the transform based on a quantization parameter (QP), a quantization matrix, or an index value for the quantization.

12. The device of claim 8, further comprising:
an inverse quantization circuitry coupled to the quantization circuitry and the neural network and to perform the inverse quantization operations to generate the dequantized transformed residual block, wherein the neural network is to generate the recovered transform block based on the dequantized transformed residual block.

13. The device of claim 12, further comprising:
a binary classification network coupled to the neural network to receive the recovered transform block and to generate a numerical confidence score for the recovered transform block; and
a selection circuitry coupled to the binary classification network to receive the confidence score as a control signal, coupled to the inverse quantization circuitry to receive the dequantized transformed residual block, and coupled to the neural network to receive the recovered transform block,
wherein the selection circuitry is to generate a selected dequantized transformed block,
wherein in response to the confidence score being higher than a predetermined threshold value, the selection circuitry is to generate the selected dequantized transformed block to be the recovered transform block, and
wherein in response to the confidence score being lower than or equal to the predetermined threshold value, the selection circuitry is to generate the selected dequantized transformed block to be the dequantized transformed residual block.

14. The device of claim 13, wherein the binary classification network comprises:
a first layer of nodes to receive an input vector converted from the recovered transform block comprising the recovered transform coefficients organized in a two-dimensional matrix format, and further generate a first layer result vector for the input vector; and
a second layer comprising a node to receive the first layer result vector to generate the confidence score.

15. The device of claim 14, wherein the binary classification network is trained using a loss function comprising a binary cross-entropy function to generate the confidence score.

16. The device of claim 13, further comprising:
an inverse transform circuitry coupled to the selection circuitry to perform an inverse transform on the selected dequantized transformed block to generate a reconstructed residue block; and
an addition circuitry to add the reconstructed residue block to the predicted block to generate a reconstructed image block.

17. The device of claim 16, wherein the prediction circuitry is to receive the reconstructed image block and is to perform another prediction operation to generate another predicted block for another input block of the image.

18. The device of claim 16, further comprising:
an in-loop filtering circuitry to perform a filtering operation on a reconstructed image comprising a plurality of reconstructed image blocks corresponding to the plurality of input blocks of the image and to generate a filtered reconstructed image.

19. A method performed by a device, comprising:
storing, in a memory device, data of an image comprising a plurality of input blocks;
performing, by a prediction circuitry, a prediction operation on an input block of the image to generate a predicted block for the input block;
performing, by a transform circuitry, a transform on a residual block to generate a transformed residual block for the residual block between the input block and the predicted block;
performing, by a quantization circuitry, quantization operations on the transformed residual block to generate a quantized transformed residual block; and
generating, by a neural network, a recovered transform block comprising recovered transform coefficients for the quantized transformed residual block to reduce errors introduced by the quantization circuitry, wherein a first error between the recovered transform block and the transformed residual block is smaller than a second error between the transformed residual block and a dequantized transformed residual block generated by performing inverse quantization operations on the quantized transformed residual block, and wherein the first error and the second error are determined based on a cost function.

20. The method of claim 19, wherein the cost function is a sum of square error function (SSE), a mean squared error (MSE) function, a sum of absolute deviations (SAD) cost function, a structural similarity index (SSIM) cost function, or a sum of absolute errors (SAEL) function.
